(19) United States
(12) Patent Application Publication
(10) Pub. No.: US 2009/0003452 A1
(43) Pub. Date: Jan. 1, 2009

(54) WYNER-ZIV SUCCESSIVE REFINEMENT VIDEO COMPRESSION

(75) Inventors: Oscar Chi Lim Au, Hong Kong (CN); Xiaopeng Fan, Hong Kong (CN)

Correspondence Address: AMIN, TUROCY & CALVIN, LLP, 127 Public Square, 57th Floor, Key Tower, CLEVELAND, OH, 44114, US

(73) Assignee: The Hong Kong University of Science and Technology, Hong Kong (CN)

(21) Appl. No.: 12/147,457

(22) Filed: Jun. 26, 2008

Related U.S. Application Data
(60) Provisional application No. 60/947,209, filed on Jun. 29, 2007.

(51) Int. Cl. H04B 1/66; H04N 7/12

(52) U.S. Cl. 375/240.17; 375/240.16; 382/238; 382/251; 375/E07.104; 375/E07.105

(57) ABSTRACT

Improved methods, systems, and devices for Wyner-Ziv video compression are provided based on the disclosed successive resolution refinement techniques. The disclosed resolution refinement schemes improve rate-distortion performance, visual quality and decoding speed with lower complexity than conventional bitplane refinement methods. The disclosed details enable various refinements and modifications according to system design considerations.

### CROSS-REFERENCE TO RELATED APPLICATIONS

This application claims the benefit of priority under 35 U.S.C Section 119 from U.S. Provisional Patent Application Ser. No. 60/947,209 entitled “WYNER-ZIV SUCCESSIVE REFINEMENT VIDEO COMPRESSION”, filed on Jun. 29, 2007.

### TECHNICAL FIELD

The subject disclosure relates to video compression, and more specifically to methods, devices and systems for performing Wyner-Ziv successive refinement video compression.

### BACKGROUND

In the 1970s, Slepian and Wolf proved that distributed correlated sources can be compressed separately with no rate increase overjoint compression. Wyner and Ziv extended one case of this problem (e.g., encoding with side information only available at a decoder) to lossy compression and established a rate distortion function. A zero rate loss from joint compression to separate compression for quadratic Gaussian case was also proven. For many other sources, this coding efficiency loss was also proven to be bounded.

To realize Distributed Source Coding (DSC) systems, many approaches have been proposed, including coset codes and near optimal channel codes such as TURBO and Low Density Parity Check (LDPC). In those approaches, the key idea is to imagine a virtual channel between source and side information. Parity bits of source symbols are generated and sent to the decoder as a bitstream, which can be used to estimate the original source symbol. As a result, the DSC problem is essentially converted into a channel coding problem, with error correction codes employed to correct channel errors.

By introducing DSC to video compression, a prediction frame as side information for a current frame is no longer needed at an encoder according to the Wyner-Ziv theorem. Therefore, in a Wyner-Ziv Video Compression (WZVC) system, each frame is compressed separately, while prediction frames are only generated at the decoder. One advantage that results is that this allows for a very low complexity encoder, since motion estimation processes can be shifted to the decoder.

A further advantage is that this scheme provides high efficiency video compression for distributed sources, because no communication is needed between each encoder. An additional advantage is that channel code based DSC approaches are insensitive to side information error, which makes WZVC systems more robust and more naturally error resilient. Another advantage is that, in WZVC systems, reconstruction synchronization between an encoder and a decoder is not necessary, resulting in a state-free scalable encoder which can overcome mismatch problems (e.g., drifting effects) in traditional Fine Granularity Scalability (FGS) schemes.

One result of implementing WZVC systems is that a decoder is used to estimate a prediction frame (e.g., due to the low complexity video encoder and the distributed video compression). As a result, motion estimation at the decoder can be a challenging task, due to the absence of a current frame used to provide a motion estimation reference. Motion Compensated Interpolation (MCI) and Motion Compensated Extrapolation (MCE) have been used in WZVC systems, which take advantage of the correlation between adjacent reconstructed frames' motion fields. Such WZVC systems typically outperform conventional intra-frame encoders. MCE/MCI based WZVC systems can provide gains of up to 6 decibel (dB) gain over intra-frame encoders in Peak Signal to Noise Ratio (PSNR), but the performance is 6 dB compared with using ideal motion compensation, which can leave room for improvement. Accordingly, further motion estimation accuracy is desired.

It has been suggested that extra symbols can be sent to a decoder to improve motion estimation (e.g., extra CRC symbols, hash symbols, or residue hash symbols) in conjunction with joint motion estimation and Wyner-Ziv decoding. For example, bit-plane refinement schemes have been proposed with gains of up to 2-3 dB over MCE/MCI based WZVC. Recent proposals have used multi-view image compression, where displacement between two frames can be estimated during Slepian-Wolf Codec (SWC) decoding. However, with the above two methods using joint Motion Estimation (ME) and Wyner-Ziv decoding, ME complexity can increase by an unacceptably large degree. As a result, further improvements and optimizations are desired, which also keep the decoder complexity low.

The above-described deficiencies are merely intended to provide an overview of some of the problems encountered in implementing Wyner-Ziv video compression and are not intended to be exhaustive. Other problems with the state of the art may become further apparent upon review of the description of the various non-limiting embodiments of the disclosed subject matter that follows.

### SUMMARY

In consideration of the above-described deficiencies of the state of the art, various non-limiting embodiments of the disclosed subject matter provide novel Wyner-Ziv Successive Refinement (WZSR) video compression methods, devices, and systems, which take advantage of the scalability of Wyner-Ziv coding systems. The disclosed subject matter provides improved motion estimation accuracy as well as overall compression efficiency, while keeping the decoder complexity low.

According to various non-limiting embodiments, lower layer reconstruction frames are used to refine motion vectors and side information for higher layer(s), while final stage motion vectors are used to predict initial motion vectors of future frames. According to various non-limiting embodiments, the disclosed subject matter provides a resolution refinement approach, which has better Rate-Distortion (RD) performance and much lower complexity than original bit-plane refinement approaches, according to the results and analyses below. According to further non-limiting embodiments, the disclosed subject matter combines dithered quantization and adaptive low pass filtering to improve visual quality as well as RD performance for pixel domain Wyner-Ziv video compression systems.

A simplified summary is provided herein to help enable a basic or general understanding of various aspects of exemplary, non-limiting embodiments that follow in the more detailed description and the accompanying drawings. This summary is not intended, however, as an extensive or exhaustive overview. The sole purpose of this summary is to present some concepts related to the various exemplary non-limiting embodiments of the disclosed subject matter in a simplified form as a prelude to the more detailed description that follows.

### BRIEF DESCRIPTION OF THE DRAWINGS

The Wyner-Ziv successive refinement video compression devices, systems, and methods are further described with reference to the accompanying drawings in which:

FIG. 1a illustrates an exemplary non-limiting Wyner-Ziv (WZ) coding and decoding system to which optimizations and methodologies of the disclosed subject matter are generally applicable;

FIG. 1b illustrates an exemplary non-limiting WZ video coding and decoding system with Motion Compensated Extrapolation and Motion Compensated Interpolation (MCE/MCI) to which optimizations and methodologies of the disclosed subject matter are generally applicable;

FIG. 2 illustrates an exemplary non-limiting block diagram of a two stage successive refinement coding and decoding system to which optimizations and methodologies of the disclosed subject matter are generally applicable;

FIG. 3a illustrates an exemplary non-limiting block diagram of a two stage WZSR video coding and decoding system according to various non-limiting embodiments of the disclosed subject matter;

FIG. 3b illustrates an exemplary non-limiting block diagram of a two stage WZSR video coding and decoding system according to further non-limiting embodiments of the disclosed subject matter;

FIG. 3c illustrates an exemplary non-limiting block diagram of a n-stage WZSR video coding and decoding system according to further non-limiting embodiments of the disclosed subject matter;

FIG. 4 is a block diagram of exemplary non-limiting methodologies for coding and decoding a video sequence according to various aspects of the disclosed subject matter;

FIGS. 5a-f depict subjective comparisons of two sequence frames at similar Peak Signal to Noise Ratio (PSNR) according to particular non-limiting embodiments of the disclosed subject matter; FIGS. 5a and 5d are the original frames;

FIGS. 5b and 5e are frames shown with dithered quantization; FIGS. 5c and 5f are frames shown with dithered quantization and low pass filtering; FIGS. 5a and 5d-f use quantization step Δ=32; FIGS. 5b and 5c use quantization step Δ=64;

FIGS. 6a-c depict exemplary non-limiting downsample patterns suitable for use according to various non-limiting embodiments of the disclosed subject matter; FIG. 6a depicts an 8-Queen pattern; FIG. 6b depicts a 4-Queen pattern; FIG. 6c depicts a 4-stage successive downsample pattern;

FIGS. 7a-d demonstrate exemplary non-limiting relationships between residue variance σₑ² and horizontal downsample ratio rₓ (rₓ=r_{y}=\sqrt{r}) according to various non-limiting embodiments of the disclosed subject matter;

FIG. 8 tabulates exemplary non-limiting optimal downsample ratios for several input video sequences according to particular non-limiting embodiments of the disclosed subject matter;

FIGS. 9a-b depict exemplary non-limiting optimal downsample ratios r* and saved rate ΔR(r*) for r_{∞}=80.1 according to one aspect of the disclosed subject matter;

FIG. 10 illustrates an exemplary non-limiting block diagram of an ideal WZ video coding and decoding system with none-causal Motion Estimation (ME) for comparison of particular non-limiting embodiments of the disclosed subject matter;

FIGS. 11a-d depict exemplary non-limiting comparative Rate-Distortion (RD) performance for P frame, Quarter Common Intermediate Format (QCIF) at 15 Hz, for several input video sequences according to particular non-limiting embodiments of the disclosed subject matter;

FIGS. 12a-b depict exemplary non-limiting comparative decoder complexity for P frame and B frame according to particular non-limiting embodiments of the disclosed subject matter;

FIGS. 13a-d depict exemplary non-limiting comparative Rate-Distortion (RD) performance for the B frame, QCIF at 7.5 Hz, for several input video sequences according to particular non-limiting embodiments of the disclosed subject matter;

FIGS. 14a-b illustrates an exemplary non-limiting block diagram of a particular non-limiting embodiment of a video coding and decoding system suitable for practicing the disclosed subject matter;

FIG. 15 is a block diagram representing an exemplary non-limiting networked environment in which the disclosed subject matter can be implemented; and

FIG. 16 is a block diagram representing an exemplary non-limiting computing system or operating environment in which the disclosed subject matter can be implemented.

### DETAILED DESCRIPTION

### Overview

Simplified overviews are provided in the present section to help enable a basic or general understanding of various aspects of exemplary non-limiting embodiments that follow in the more detailed description and the accompanying drawings. This overview section is not intended, however, to be considered extensive or exhaustive. Instead, the sole purpose of the following embodiment overviews is to present some concepts related to some exemplary non-limiting embodiments of the disclosed subject matter in a simplified form as a prelude to the more detailed description of these and various other embodiments of the disclosed subject matter that follow. It is understood that various modifications can be made by one skilled in the relevant art without departing from the intent of the disclosed invention. Accordingly, it is the intent to include within the scope of the disclosed subject matter those modifications, substitutions, and variations as may come to those skilled in the art based on the teachings herein.

As described above, further improvements in motion estimation accuracy as well as overall compression efficiency is desired for Wyner-Ziv Video Compression (WZVC) systems while keeping the decoder complexity low.

In consideration of the foregoing and related ends, in accordance with exemplary non-limiting embodiments of the disclosed subject matter, lower layer reconstruction frames can be used to refine motion vectors and side information for higher layer(s), while final stage motion vectors can be used to predict initial motion vectors of future frames. According to various non-limiting embodiments, the disclosed subject matter provides resolution refinement approaches, which have better Rate-Distortion (RD) performance and much lower complexity than original bit-plane refinement approaches, according to the results and analyses below. According to further non-limiting embodiments, the disclosed subject matter can combine dithered quantization and adaptive low pass filtering to improve visual quality as well as RD performance for pixel domain Wyner-Ziv video compression systems.

In order to provide a better understanding of the description of the disclosed subject matter with reference to the figures identified below, the following abbreviations are used herein (e.g., Motion Compensated Extrapolation (MCE); Motion Compensated Extrapolation and Motion Compensated Interpolation (MCE/MCI); Motion Compensated Refinement (MCR); Motion Compensation (MC); Motion Estimation and Motion Compensation (ME&MC); Motion Vector Projection (MVP); Motion Vectors (MVs); Quantization/Dequantization (Q/Q⁻¹); Slepian-Wolf Codec (SWC/SWC⁻¹); Wyner-Ziv Codec (WZC/WZC⁻¹)).

Wyner-Ziv Theorem, Wyner-Ziv Video Compression, and Wyner-Ziv Successive Refinement

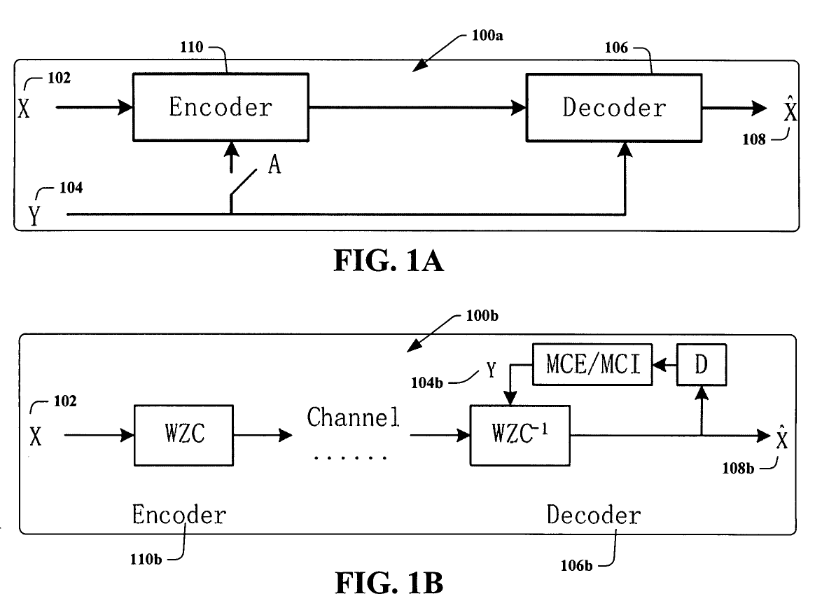

FIG. 1a illustrates a Wyner-Ziv (WZ) coding and decoding system 100a. As described above, one problem in the Wyner-Ziv theorem concerns the lossy compression of a source X 102 when its prediction frame Y 104 (e.g., side information) is only available at decoder 106, as shown in FIG. 1a. More strictly, X 102 and Y 104 represent samples of two Independent, Identically Distributed (i.i.d.) random sequences of possibly infinite alphabets x and y modeling source data and side information respectively. The reconstruction \hat{X} 108 takes values in alphabet x, and is restricted by distortion constraint E(d(X,\hat{X}))≦D, where d(.) is the distortion measure function. According to rate distortion theory, if Y 104 is available at both encoder 110 and decoder 106, the minimum rate to encode X 102 is:

R_{X|Y}(D)=min I(X;\hat{X}|Y) (1)

where the minimization is taken over all possible R.V. \hat{X} 108 that satisfies E(d(X,\hat{X}))≦D.

Wyner-Ziv theorem indicates that, given Y 104 at decoder 106 only, minimum rate to encode X 102 is:

R_{X|Y}^{WZ}(D)=min I(X;Z|Y) (2)

where the minimization is taken over all random variable Z, such that Z→X→Y is a Markov chain and there exists a function ƒ of Y 104 and Z and E(X,ƒ(Y,Z))≦d.

Here the condition Z→X→Y is equivalent to I(Y;Z|X)=0, which guarantees that Z should not contain more information of Y 104 than X 102. This is important to prevent Y's information becoming available to encoder through Z.

As to the relationship between Eqns. (1) and (2), it is obvious that:

R_{X|Y}(D)≦R_{X|Y}^{WZ}(D) (3)

But Wyner and Ziv proved that for joint distributed Gaussian source under Mean Square Error (MSE) distortion measure, this rate increase is zero for the quadratic Gaussian case:

R_{X|Y}(D)=R_{X|Y}^{WZ}(D) (4)

This conclusion was further extended for the quadratic Gaussian case relaxed to the condition that only X-Y need to be Gaussian and independent of Y 104. For many sources other than Gaussian, the gap can be shown to be bounded.

FIG. 1b illustrates a WZ video coding and decoding system with Motion Compensated Extrapolation and Motion Compensated Interpolation (MCE/MCI). The quadratic Gaussian case is important for video compression, because the residue frame can be assumed to satisfy Gaussian distribution, and video distortion measure Peak Signal to Noise Ratio (PSNR) is equivalent to MSE. As a result, a Wyner-Ziv video coding system can perform similar to conventional video compression systems, as long as side information Y has similar prediction quality.

However, due to the absence of current frame as a prediction reference, it is difficult to get similar quality side information Y 104 in practical Wyner-Ziv system, where side information 104b is generated at decoder 106b only. In such systems, the prediction of the inter frames are typically generated from adjacent frames through frame level Motion Compensated Extrapolation and Motion Compensated Interpolation (MCE/MCI) for Wyner-Ziv ‘B-frame’ and ‘P-frame’ respectively, as shown in FIG. 1b. As a result of the delay before each decoded frame reaches the MCE/MCI module, the system is causal and practical. However, the prediction accuracy of both MCE and MCI are much lower than traditional motion compensation.

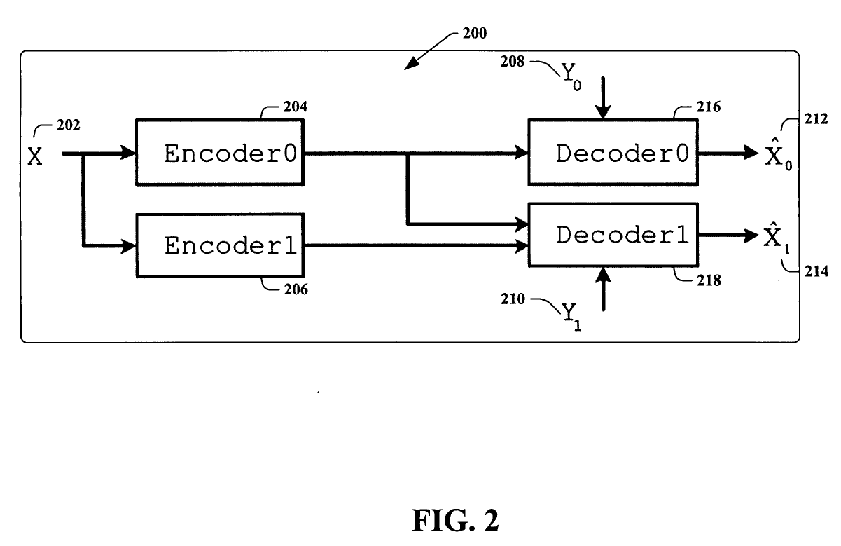

FIG. 2 illustrates a block diagram of a two stage successive refinement coding and decoding system. Wyner-Ziv Successive Refinement (WZSR) has been proposed to improve the prediction accuracy by encoding a source 202 successively at multiple stages (204, 206), with different side information (208, 210) and distortion requirements at each stage. FIG. 2 depicts a special case of a two-stage successive refinement system where source X 202 is successively compressed by a coarse stage and a refinement stage, to reconstruct \hat{X}₀ 212 and \hat{X}₁ 214 at the decoder (216, 218), respectively. At the coarse stage, only coarse side information Y₀ 208 is available to the decoder 216, while at the refinement stage a better side information Y₁ 210 is available to decoder 218. It is noted that Y₁ 218 is better than Y₀ 216, if X→Y₁→Y₀ is a Markov chain. When this successive degradation condition holds, the rate distortion function for this successive refinement system can be shown. Denoting \vec{D}=(D₀,D₁) as distortion constraint, where D₀ and D₁ are constraints for \hat{X}₀ 212 and \hat{X}₁ 214 respectively. The total rate R_{X|Y}_{₀}_{,Y}_{₁}^{SR}(\vec{D}) satisfies:

R_{X|Y}_{₀}_{,Y}_{₁}^{SR}(D)≧R_{X|Y}_{₁}^{WZ}(D₁) (5)

where the gap is the cost to achieve flexibility and scalability.

For the normal situation D₀≧D₁ (e.g., the reconstruction of refinement stage is better than coarse stage), then:

R_{X|Y}_{₀}_{,Y}_{₁}(\vec{D})≦R_{X|Y0}^{WZ}(D₁) (6)

which follows, because arbitrary applicable bitstreams for right side Wyner-Ziv system is also suitable for left side WZSR system.

The rate relationship as denoted by Eqns. (5) and (6) indicate that the performance of this successive refinement scheme is between two hypothetical Wyner-Ziv coders with coarse and fine side information at the decoder respectively:

R_{X|Y}_{₁}^{WZ}(D)≦R_{X|Y}_{₀}_{,Y}_{₁}^{SR}(D₀,D₁)≦R_{X|Y}_{₀}^{WZ}(D) (6.1)

where R_{X|Y}_{₀}^{WZ}(D) and R_{X|Y}_{₁}^{WZ}(D) are the minimum rates of two hypothetical Wyner-Ziv coders with Y₀ 208 and Y₁ 210 as side information at the decoders (216, 218) respectively, and D=D₁.

Successive refinement has been applied in robust scalable video stream transmission, where the enhancement layer of a Fine Granularity Scalability (FGS) system can be encoded by Wyner-Ziv code to benefit error resilience performance. However, as described above, improvements are desired which can overcome the mismatch problems (e.g., drifting effects) in traditional FGS systems. To the related and foregoing ends, the disclosed subject matter applies Wyner-Ziv successive refinement in general Wyner-Ziv video coding systems and methods (e.g., compression systems and methods) to improve side information quality, rate-distortion performance, visual quality, and decoding speed with lower complexity. By utilizing the natural scalability of Wyner-Ziv coders, including resolution scalability and Signal to Noise Ratio (SNR) scalability, lower layer reconstruction can be used to refine motion vectors for higher layers.

Wyner-Ziv Successive Refinement (WZSR) Video Compression

Wyner-Ziv video coding systems remove temporal redundancy at the decoder. To further improve coding efficiency, transform domain Wyner-Ziv video coders have been proposed to exploit spatial redundancy. Advantageously, according to various non-limiting embodiments, the disclosed subject matter provides pixel domain Wyner-Ziv video codecs in order to keep encoder complexity low. As a further advantage, the disclosed subject matter can facilitate exploiting spatial redundancy through combinations of dithered quantization and low pass filtering. As will be apparent to one skilled in the art, various embodiments of the disclosed subject matter can be conveniently extended to transform domain Wyner-Ziv video codec schemes. Thus, such modifications as well as other modifications apparent to one skilled in the art are intended to be encompassed within the scope of the disclosed subject matter as claimed.

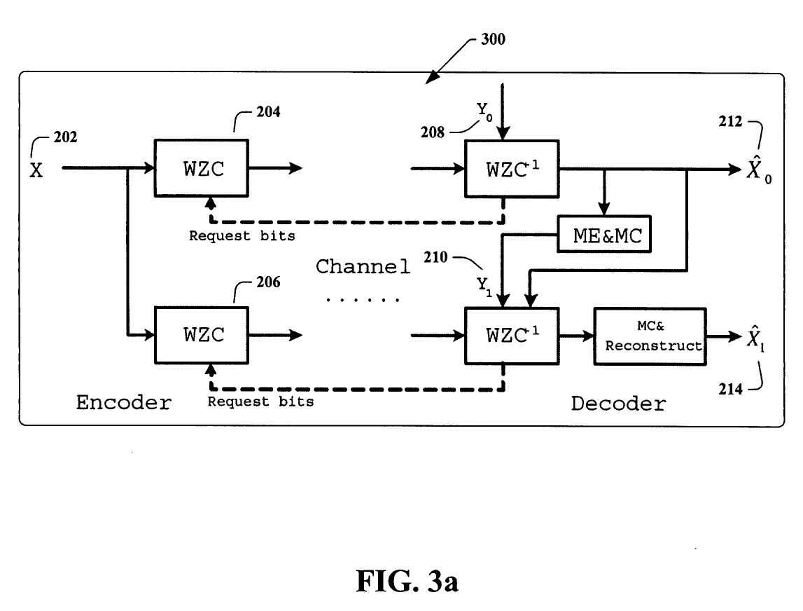

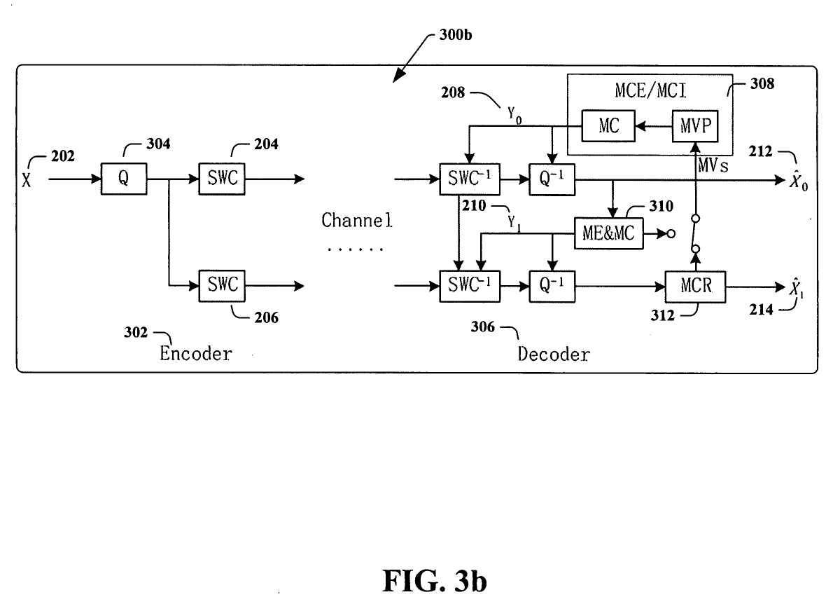

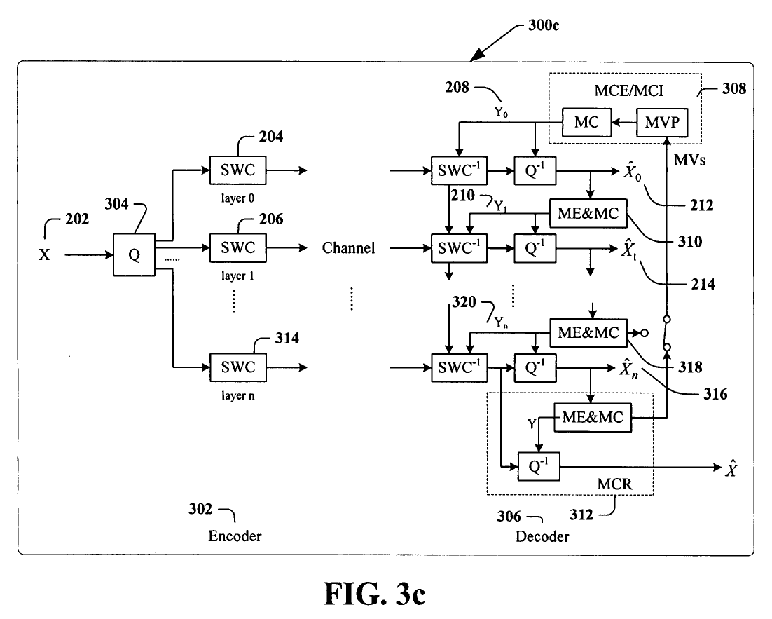

FIG. 3 a illustrates an exemplary non-limiting block diagram of a two stage WZSR video coding and decoding system according to various non-limiting embodiments of the disclosed subject matter, as described above with reference to FIG. 2.

According to various non-limiting embodiments, the WZSR video compression of the disclosed subject matter improves motion compensation accuracy as well as compression efficiency over conventional MCE/MCI based Wyner-Ziv Video Compression (WZVC) which can suffer from low quality side information. With the disclosed subject matter each frame X 202 can be successively encoded by several stages, using lower layer reconstruction to refine motion vectors as well as side information for higher layers.

FIG. 3b illustrates an exemplary non-limiting block diagram of a two stage WZSR video coding and decoding system according to further non-limiting embodiments of the disclosed subject matter. At the encoder 302, after quantization 304, binaries can be divided into multiple partitions (e.g., two partitions) containing base layer bins and enhance layer bins respectively, according to an aspect of the disclosed subject matter. These partitioned bins can be compressed (e.g., by a Slepian-Wolf codec (SWC)) (204, 206) and transmitted to a decoder 306. At the decoder 306, base layer bins can be decoded first by using prediction frame Y₀ 208 as side information (e.g., by using a MCE/MCI 308 based prediction frame). The decoder 306 can then perform motion estimation 310 (e.g., by using base layer reconstruction as a block matching target) to find better prediction frame Y 210. According to a further aspect of the disclosed subject matter, the better prediction frame Y 210 can be used as side information in decoding enhance layer bins. According to a further aspect of the disclosed subject matter, after all bins are decoded, the decoder 306 can perform (an optional) motion compensated refinement (MCR) to improve reconstruction quality.

FIG. 3c depicts an exemplary non-limiting block diagram of n-stage embodiments of the disclosed subject matter. For example, at the encoder 302, each of the pixels can be quantized 304 and represented first by binary symbols. Then the binary symbols can be divided into n groups. Note that it is not necessary that the binary symbols from the same pixel be divided into the same group. Then, each group of binary symbols can be encoded by one coding layer (204, 206, . . . , 314). The SWC of each layer (204, 206, . . . , 314) can then encode the binary symbols and transmit the bitstreams to the decoder 306. At the decoder 306, the binary symbols of the base layer (layer 0) can be first decoded by using Y₀ 208 as the side information (e.g., where Y₀ 208 is the best known prediction frame at this base layer stage and can be obtained through MCI, MCE or any other estimation schemes at the decoder 306). Then motion estimation 310 can be performed with the help of the base layer reconstruction \hat{X}₀ 212 to find a more accurate prediction frame Y 210. This better prediction frame Y₁ 210 can subsequently be used as the side information in SWC decoding of layer 1, while the reconstruction \hat{X}₁ 214 again helps to refine the motion vectors to find the next layer's side information Y₂ (not shown). Advantageously, according to various non-limiting embodiments, the disclosed subject matter can repeat the successive refinement process for the reconstructions 316, the motion vectors 318 and the side information 320 alternatively and sequentially, until all layers have been decoded. Finally, the disclosed subject matter can refine the motion vectors and the side information again to improve the de-quantization accuracy of the reconstruction frames (e.g. improving reconstruction quality through (MCR) 312). Because the quality of the side information (208, 210, . . . , 320) is successively improved during the decoding process, according to Eqn. (6.1), the various embodiments of the disclosed subject matter advantageously have a lower bit rate than the original MCI/MCE based Wyner-Ziv video coding schemes, under the same distortion constraint.

In view of the exemplary systems described supra, methodologies that can be implemented in accordance with the disclosed subject matter will be better appreciated with reference to the flowcharts herein. While for purposes of simplicity of explanation, the methodologies are shown and described as a series of blocks, it is to be understood and appreciated that the claimed subject matter is not limited by the order of the blocks, as some blocks can occur in different orders and/or concurrently with other blocks from what is depicted and described herein. Where non-sequential, or branched, flow is illustrated via flowchart, it can be appreciated that various other branches, flow paths, and orders of the blocks, can be implemented which achieve the same or a similar result. Moreover, not all illustrated blocks may be required to implement the methodologies described hereinafter.

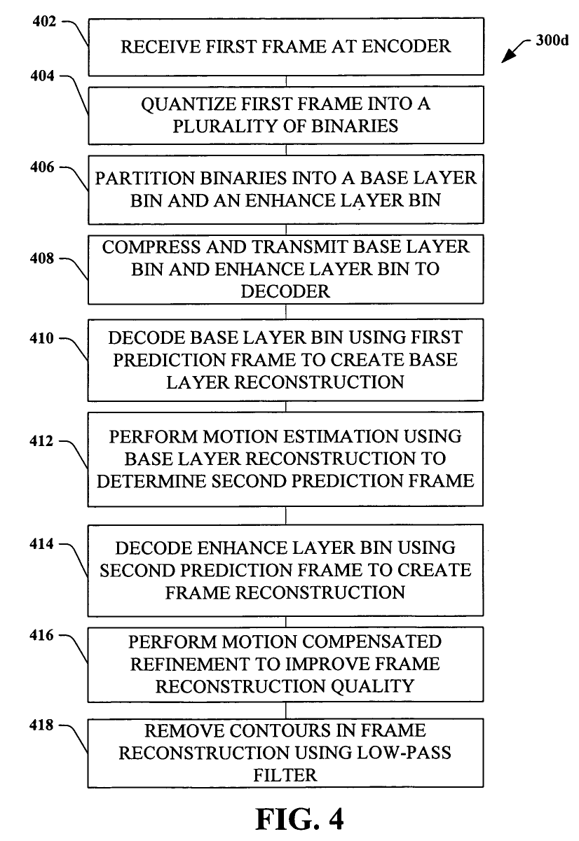

Accordingly, FIG. 4 is an exemplary non-limiting block diagram of methodologies for coding and decoding a video sequence according to various aspects of the disclosed subject matter. At 402, the methodologies can comprise receiving a first frame of a plurality of frames at an encoder. At 404, the methodologies can further comprise quantizing a first frame into a plurality of binaries. Additionally, at 406, the methodologies can include partitioning plurality of binaries into a base layer bin and an enhance layer bin. Accordingly, at 408, the methodologies can further include compressing and transmitting the bins to a decoder. At 410, the methodologies can comprise decoding the base layer bin using a first prediction frame to create a base layer reconstruction. In addition, at 412, the methodologies can comprise performing a motion estimation to determine a second prediction frame. At 414, the methodologies can further comprise decoding the enhance layer bin using the second prediction frame to create a frame reconstruction having a quality. Additionally, at 416 the methodologies can comprise performing a motion compensated refinement at the decoder after all bins are decoded to improve the frame reconstruction quality. At 418, the methodologies can further comprise removing contours in the frame reconstruction using a low-pass filter.

It should be noted that the Markov chain condition X→Y→Y₀ should apply, because otherwise Y₁=(Y₀,Y₁) can be new side information which can satisfy the Markov chain condition, and which is also available to the enhance layer decoder. A practical interpretation is that, motion estimation accuracy will increase when there is more information about the current frame. As a result, from Eqn. (6) the disclosed subject matter advantageously provides a lower bitrate than original MCE/MCI based Wyner-Ziv video compression schemes. According to various aspects of the disclosed subject matter, this improvement comes from the quality enhancement of side information used at the enhance layer. According to further non-limiting embodiments of the disclosed subject matter, a multiple stage WZSR video compression provides better bitrate than the exemplary two-stage system.

According to various non-limiting embodiments, the disclosed subject matter achieves the desired results without excessive computation for the repeated motion estimation. First, in MCI and MCE, the disclosed subject matter estimates motion vectors by using previous (e.g., previous in decoding order) frame's motion vectors, with very insignificant complexity compared with conventional Motion Estimation (ME). Second, the disclosed subject matter provides a resolution refinement approach, which has recursive Sum of Absolute Differences (SADs) calculation, which results in similar complexity with single motion estimation approaches.

### Refinement Strategies

Herein, two exemplary refinement strategies are implemented and compared. The first one is the bitplane refinement strategy, which is similar to previously proposed bitplane refinement strategies. To that end, each bitplane, for example from Most Significant Bit (MSB) to Least Significant Bit (LSB), can be encoded by one Slepian-Wolf codec in each layer, from base layer to highest enhance layer. At the decoder, each layer can use lower layers' bins in motion estimation to refine motion vector as well as prediction frame. Although this approach can provide up to a 3 dB gain over a conventional Wyner-Ziv codec strategy, one drawback is that the repeated motion estimation requires high complexity at the decoder.

To avoid high complexity as well as improve Rate-Distortion (RD) performance, the disclosed subject matter provides novel resolution refinement strategies that can utilize spatial scalability of Wyner-Ziv video compression. To that end, binaries can be distributed to different encoding layers according to respective pixel locations. Those binaries quantized from lowest resolution pixels can be encoded in base layers, while binaries from higher resolution pixels can be encoded in higher layers. At the decoder, each layer can use previous decoded low resolution pixels to refine motion vectors and improve prediction frames. In motion estimation, the disclosed subject matter facilitates allowing each layer to store its SADs and pass them to higher layer(s). Advantageously, the disclosed subject matter allows for reduced complexity by allowing each layer to only calculate SADs for new emerging pixels. As a result, the total count of SAD calculations can be shown to remain the same relative to single motion estimation.

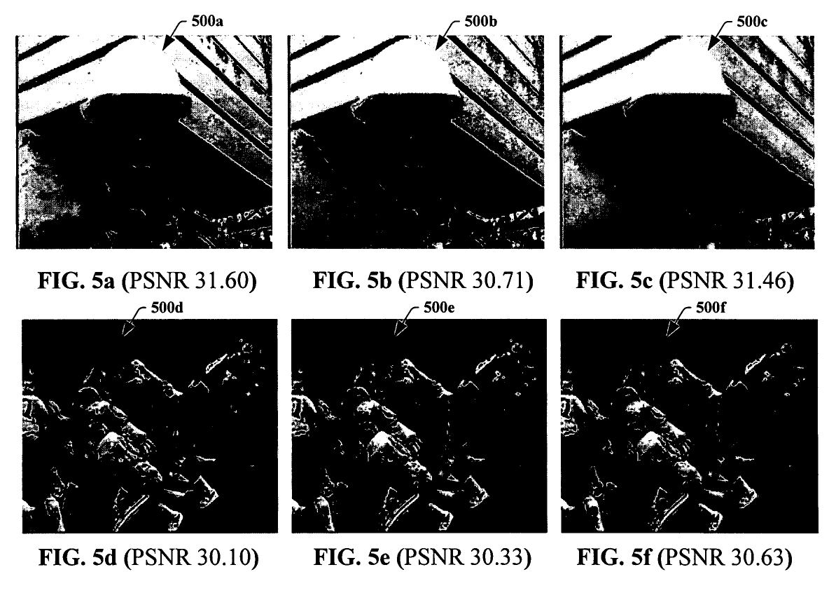

FIGS. 5a-f depict subjective comparisons of two sequence frames at similar Peak Signal to Noise Ratio (PSNR) according to particular non-limiting embodiments of the disclosed subject matter. FIGS. 5a and 5d are the original frames, whereas FIGS. 5b and 5e are frames shown with dithered quantization. FIGS. 5c and 5f are shown with dithered quantization and low pass filtering. Additionally, FIGS. 5a and 5d-f are the results of using quantization step Δ=32, whereas FIGS. 5b and 5c are the results of using quantization step Δ=64.

### Quantization and Reconstruction

According to further non-limiting embodiments of the disclosed subject matter, dithered quantization and low pass filtering can be applied to reduce intra frame redundancy and contour effects (e.g., see FIG. 5(a) and (e)) which can exist in general pixel domain Wyner-Ziv video codecs. According to an aspect of the disclosed subject matter, each pixel can be quantized by a uniform scalar quantizer with random threshold location (e.g., quantize each pixel with same step quantizer with different threshold location). According to a further aspect of the disclosed subject matter, the threshold location can be controlled by a Pseudo random variable

$$N \sim u ( - \frac{Δ}{2} , \frac{Δ}{2} ) ,$$

where Δ can denote the quantization step size. Alternatively, this can be viewed as adding and subtracting N before quantization and after dequantization respectively. Advantageously, the dithered quantization itself does not affect RD performance, because for each pixel it is still a normal uniform quantization. As a further advantage, the resulting quantization noise of neighbor pixels becomes independent and more easily reduced by a low pass filter, while pixel value is preserved because of intra correlation.

As a result, the disclosed subject matter can effectively remove contour effects as well as improve RD performance according to particular embodiments. For example, in FIGS. 5b-5c, significant visual quality improvement can be subjectively observed over the original frame in FIG. 5a, although FIGS. 5b-5c use much bigger quantization step size (e.g., 64 versus 32 for FIG. 5a).

In addition, it can be shown that at the decoder after SWC decoding, the possible value range of each pixel x is already known:

xε[x⁻,x⁺] (7)

where x⁻=min(x|Q(x+n)=b), x⁺=max(x|Q(x+n)=b), and b=Q(x+n) is the quantized symbol of x.

With the help of side information y, pixel x can be reconstructed by Minimum Mean Square Error (MMSE) estimation, through:

$$\hat{x} = 𝔼 ( x \vert y , b , n ) = \frac{{\int }_{{x}^{-}}^{{x}^{+}} {xf}_{X \vert Y} ( x \vert Y = y ) d x}{{\int }_{{x}^{-}}^{{x}^{+}} {f}_{X \vert Y} ( x \vert Y = y ) d x} \qquad ( 8 )$$

The Probability Density function (PDF) ƒ_{X|Y}(x|Y=y) can be modeled by Laplacian distribution of form:

$${f}_{X \vert Y} ( x \vert Y = y ) = \frac{λ}{2} {e}^{- λ \vert x - y \vert} \qquad ( 9 )$$

where λ can be estimated for each block at frame level, through block SADᵢ and average S̅A̅D̅ for all blocks:

$${λ}_{i} = \frac{2}{{σ}^{2}} \frac{\overline{SAD}}{{SAD}_{i} + ɛ} \qquad ( 10 )$$

because of the inverse proportional relation between λ and SAD, where m denotes the number of pixels involved in the SAD calculation, and σ² is the residue variance when all pixels can be used in SAD calculation.

According to further non-limiting embodiments of the disclosed subject matter, the MMSE reconstruction can be smoothed by low pass filter (e.g., a low pass Gaussian filter) to improve visual quality and RD performance. As previously described above with reference to FIG. 4, this demonstrates the effectiveness of the disclosed subject, according to various non-limiting embodiments.

### SWC Implementation

According to various non-limiting embodiments, each pixel x can be quantized into bins b=b₀b₁ . . . bₙ where b₀ is MSB and bₙ is LSB. The bins can be assigned to different layers according to a refinement strategy (e.g., bitplane refinement, resolution refinement, etc.). At each layer, the bins can be coded (e.g., by rate adaptive Low Density Parity Check (LDPC)). Subsequently, the bins can be decoded in a specified order (e.g., from MSB to LSB for convenience), although any order would have substantially the same coding efficiency. At the j-th layer, with the help of the refined side information yⱼ and based on the conditional PDF f_{X|Y}ⱼ(x|Yⱼ=yⱼ), the intrinsic log likelihood ratio (in LLR) for each bin b₁ can be calculated at its decoding layer by:

$$\begin{matrix}i n L L R = log ( \frac{P ( {b}_{i} = 0 \vert {y}_{j} , {b}^{-} , n )}{P ( {b}_{i} = 1 \vert {y}_{j} , {b}^{-} , n )} ) \\ = log ( \frac{P ( {b}_{i} = 0 , {b}^{-} \vert {y}_{j} , n )}{P ( {b}_{i} = 1 , {b}^{-} \vert {y}_{j} , n )} ) \\ = log ( \frac{P ( x ∈ [ {x}^{-} , t ) \vert {y}_{j} , n )}{P ( x ∈ [ t , {x}^{+} ) \vert {y}_{j} , n )} ) \\ = log ( \frac{{\int }_{{x}^{-}}^{t} {f}_{X \vert {Y}_{j}} ( x \vert {Y}_{j} = {y}_{j} ) d x}{{\int }_{t}^{{x}^{+}} {f}_{X \vert {Y}_{j}} ( x \vert {Y}_{j} = {y}_{j} ) d x} ) , j = 0 , 1 , … , n - 1\end{matrix} \qquad ( 11 )$$

where x⁻=min(x|b⁻,n), x⁺=max(x|b⁻,n), and t=min(x|b⁻,bᵢ=1,n) denote quantization thresholds for current bin b₁, additive noise n, and post-decoded bins b⁻=b₀b₁ . . . bᵢ₋₁.

According to a further aspect of the disclosed subject matter, LDPC accumulate (LDPCA) decoder can receive the results of Eqn. (11) (e.g., the in LLR values) as input, and output extrinsic LLR after decoding iteration(s). Then, each bin bᵢ can estimated (e.g., estimated by a hard decision):

$${b}_{i} = \{ \begin{matrix}0 , & e x t L L R < 0 ; \\ 1 , & e x t L L R \geq 0.\end{matrix} \qquad ( 12 )$$

### Motion Estimation

According to various non-limiting embodiments, the disclosed subject matter can implement both P-frame and B-frame compression, with extreme low complexity Wyner-Ziv encoder(s). For example, Wyner-Ziv P-frames can be coded in temporal order with only one previous frame stored in the decoder buffer as a reference frame. For Wyner-Ziv B-frame, there are two reference frames in the decoder buffer (e.g., a forward frame and a backward frame). Initially at the base layer stage, motion can be estimated through adjacent post-decoded frames' motion vectors. Then at higher layer, motion can be refined based on output of lower layers. At the base layer stage, the disclosed subject matter can implement MCI and MCE without motion estimation, because motion is directly derived from previous (in decoding order) frames' motion vectors, according to various non-limiting embodiments of the disclosed subject matter.

For ‘P’ type Wyner-Ziv frames, constant motion can be assumed so that each motion vector of previous frame can be stretched onto one point in the current frame. Then, for each block in the current frame the motion vector which has nearest projection point to the center of current block can be chosen. Similarly for ‘B’ frame, the point where each motion vector passes through in the current frame can be first calculated, and then the motion vector with nearest point passing through can be selected. According to various non-limiting embodiments, all motion vectors can be assumed to be 0 for the first ‘P’ frame immediately after ‘I’ frames.

At refinement stages, the disclosed subject matter advantageously provides information of the current frame to assist in motion estimation (e.g., a downsample frame in the resolution refinement approach, or several bitplanes in bitplane refinement approach).

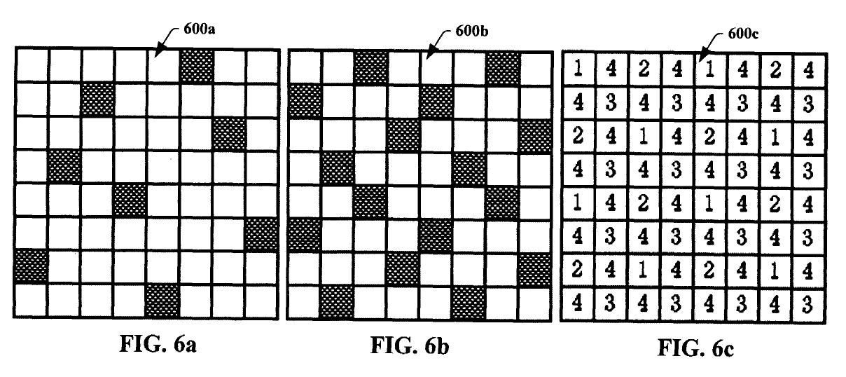

FIGS. 6a-c depict exemplary non-limiting downsample patterns suitable for use according to various non-limiting embodiments of the disclosed subject matter, wherein FIG. 6a depicts an 8-Queen pattern 600a, FIG. 6b depicts a 4-Queen pattern 600b, and FIG. 6c depicts a 4-stage successive downsample pattern 600c. According to a particular embodiment (e.g., two stage successive refinement case where we only refine motion once) the disclosed subject matter can use an N-Queen pattern in FIG. 6. In the resolution refinement approach of the disclosed subject matter, the downsample pattern is not necessarily regular because some irregular pixel decimation patterns have relatively better motion estimation accuracy.

For example, referring to FIGS. 6a-6b, black pixels can be encoded at base layer while white pixels can be encoded at enhance layer. This downsample pattern can be shown to provide better RD performance, because those black pixels are enough to ‘lock’ the edges for motion estimation. In the multistage case, in order to simplify the system, the disclosed subject matter can use the successive regular pattern 600c given in FIG. 6c, where the numbers on each pixels depict an exemplary non-limiting decoding order. It should be understood by those skilled in the art that various modifications could be substituted without departing from the scope of the claimed invention. For example, although particular embodiments are described as using a particular decimation pattern, the disclosed subject matter should not be so limited.

For both bitplane refinement and resolution refinement, due to the absence of the original pixel x, the disclosed subject matter can use quantized bins b instead in SAD calculation, based on following difference measure:

$$d ( y , b ) = {min}_{Q ( \overline{x} + n ) = b} \vert y - \overline{x} \vert \qquad ( 13 )$$

where Q(.) denotes quantization function and y is pixel value from reference frame.

To improve motion estimation accuracy, the mean of four neighbor blocks' SAD, can also contribute to current block's SAD through:

SAD′=θSAD+(1−θ) N̅S̅A̅D̅ (14)

where N̅S̅A̅D̅ is the mean of neighbor blocks' SADs, and θ is set to be 0.5.

### WZSR Video Compression Rate Distortion, Complexity Analysis, Optimal Downsample Ratio for Single Resolution Refinement and Multi-Stage Resolution Refinement Rate Redundancy Upper Bound

Rate-Distortion (RD) performance of particular embodiments can be analyzed through residue variance between the current frame and the prediction frame. Residue variance provides a good performance approximation (especially for pixel domain Wyner-Ziv video coding) since intra correlation of the residue frame is low.

### Motion Estimation Accuracy Analysis

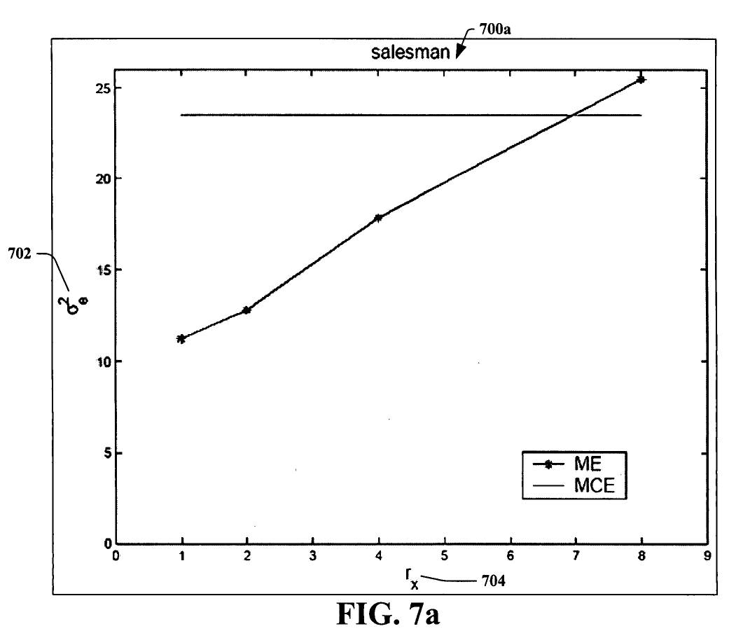

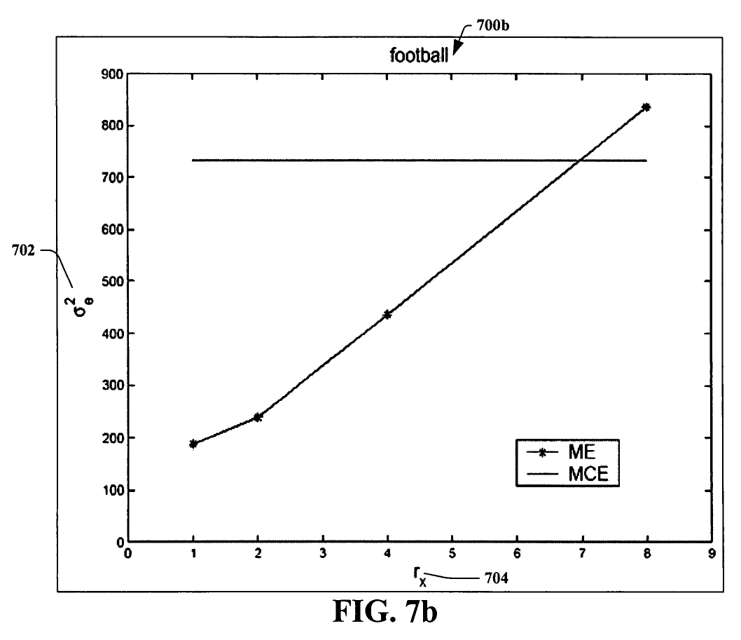

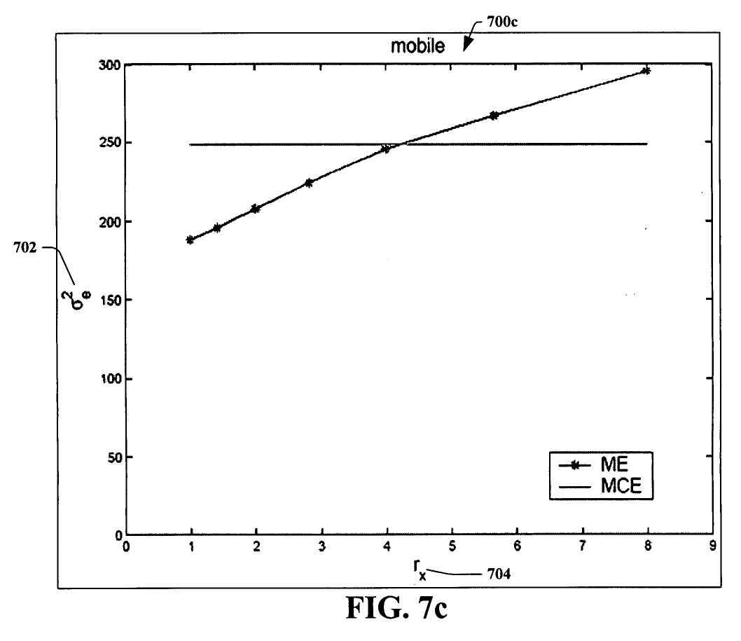

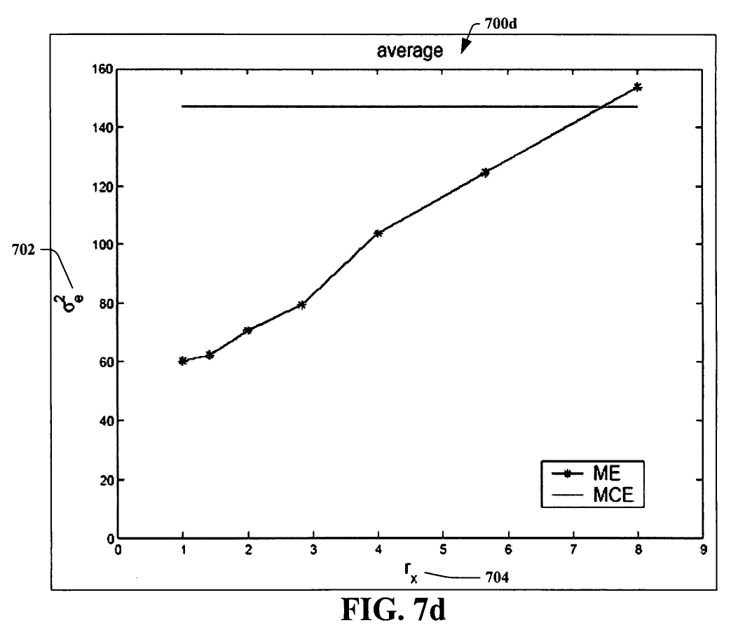

Analysis of motion estimation accuracy when only downsample pixels of the current frame are available is helpful to understand as a foundation before the rate distortion function is derived. Accordingly, denoting r=rₓr_{y} as total downsample ratio, where rₓ and r_{y} are horizontal and vertical downsample ratio respectively. Generally, rₓ=r_{y}=√\vec{r} if the downsample is directionally independent. The results can be derived from varying downsample ratio and calculating corresponding residue variance. To avoid local minima, for high downsample ratio more blocks in SAD calculation can be combined. Each block contributes different weight, depending on its distance from current block as in Eqn. (14). For the results discussed below, 100 frames are listed for each sequence, and average for 7 sequences is calculated. FIGS. 7a-d demonstrate exemplary non-limiting relationships between residue variance σₑ² 702 and horizontal downsample ratio rₓ (rₓ=r_{y}=√\vec{r}) 704, according to various non-limiting embodiments of the disclosed subject matter. As can be observed, the residue variance 702 is approximately proportional to downsample ratio rₓ 704 and √\vec{r}. This can be explained as follows.

Denoting x(i,j) as the current frame and y(i,j) as the reference frame, where (i,j) is the 2D pixel location, y(ĩ,\tilde{j})=x(i,j)+n(i,j), where mv=(ĩ,\tilde{j})−(i,j) is motion vector, and n(i,j) is the systematic residue.

If motion vector has an error Δ=(Δᵢ,Δⱼ), then the variance of the practical residue e(i,j) will become:

σₑ²=E{(x(i,j)−y(ĩ+Δᵢ,\tilde{j}+Δⱼ))²}=E{2σₙ²+σₙ²−2Rₓ(Δ)} (15)

where Rₓ(Δ) denotes the auto-correlation function of x(i,j).

x(i,j) can be assumed to be a 2D Markov field with autocorrelation function Rₓ(Δ)=σ_{z}²ρ^{|Δ|}, then:

σₑ²=2σₓ²E{1−ρ^{|Δ|}}+σₙ² (16)

≈2σₓ²(1−ρ^{|Δ|})E{|Δ|}+σₙ² (17)

where E{|Δ|} denotes the average length of motion vector error. This motion vector error can be assumed to be uniformly distributed over a 1×1 region, when the full resolution current frame is available. Supposing the current frame is downsampled by ratio r=rₓr_{y}, the motion vector error becomes a value in a rₓ×r_{y} region. If uniform distribution is assumed and rₓ=r_{y}, then:

E{|Δ|}=arₓ=a\sqrt{r} (18)

Finally, Eqn. (16) can be rewritten as:

σₑ²=A\sqrt{r}+N (19)

where N=σₙ² denotes the systematic residue variance, and A\sqrt{r} denotes the additive residue variance due to inaccurate motion. Notice that when r=1 the residue variance is A+N, because of integer motion vector accuracy.

### RD Function for Single Refinement

Under the assumption that the motion compensated residue is an i.i.d Gaussian random process with variance σ₀², the rate distortion function for Wyner-Ziv video compression can be expressed as:

$${R}^{WZ} ( D ) = \frac{1}{2} {log}_{2} ( \frac{{σ}_{0}^{2}}{D} ) \qquad ( 20 )$$

Similarly, m pixels can be encoded at the base layer with side information Y₀ at the decoder, with the remaining k−m pixels encoded at the enhance layer with refined side information Y₁. The resulting bitrate can be shown to be:

$${R}^{SR} ( D , r ) = \frac{1}{2} \frac{1}{r} {log}_{2} ( \frac{{σ}_{0}^{2}}{D} ) + \frac{1}{2} ( 1 - \frac{1}{r} ) {log}_{2} ( \frac{{σ}_{1}^{2}}{D} ) \qquad ( 21 )$$

where

$$r = \frac{m}{k}$$

is the downsample ratio, σ₀²=E(X−Y₀)² and σ₁²=E(X−Y₁)² are residue variances for the base layer and the enhance layer side information respectively.

The saved bitrate:

$$Δ R ( r ) = {R}^{WZ} ( D , r ) - {R}^{SR} ( D ) = \frac{1}{2} ( 1 - \frac{1}{r} ) {log}_{2} ( \frac{{σ}_{0}^{2}}{{σ}_{1}^{2}} ) \qquad ( 22 )$$

is independent of D and is none-negative if σ₁²≦σ₀², since the motion refinement usually decreases residue variance. As can be shown, σ₁² is approximately affine to \sqrt{r} and can be expressed as:

σ₁²≈A\sqrt{F}+N (23)

By defining

$${r}_{∞} = {( \frac{{σ}_{0}^{2} - N}{A} )}^{2} and β = \frac{N}{A} ,$$

Eqn (22) becomes:

$$Δ R ( r , β ) = \frac{1}{2} ( 1 - \frac{1}{r} ) {log}_{2} ( \frac{\sqrt{{r}_{∞}} + β}{\sqrt{r} + β} ) \qquad ( 24 )$$

which is none-negative and quasi-concave in region rε[1,r_{∞}]. ΔR(r) is 0 at point r=1 and r=r_{∞}, which is consistent with the fact that both the case of encoding all pixels at first stage and the case of encoding all pixels at second stage is equivalent to original Wyner-Ziv video coding system.

### Optimal Downsample Ratio for Single Refinement

According to various non-limiting embodiments of the disclosed subject matter, base layer side information can be improved through MCE and MCI to get different r_{∞} and r* than the case of using reference frames as the base layer side information. In this section, the optimal downsample ratio is shown as derived through numerical methods, then analytical upper and lower bound for optimal downsample ratio is derived.

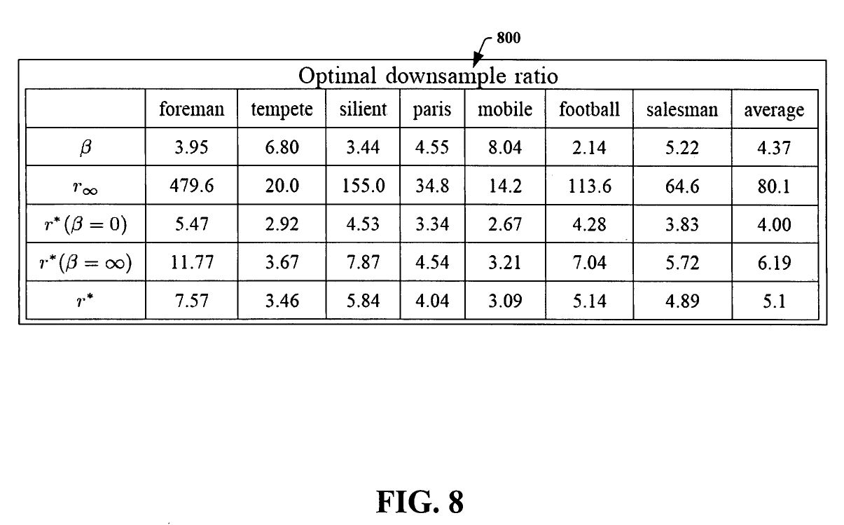

Referring back to FIGS. 7a-7d, r_{∞}=80.1 and β=4.37, where \sqrt{r_{∞}} corresponds to the intersection point of the two lines. Since Eqn. (24) is quasi-concave in region rε[1,r_{∞}], for a given β and r_{∞}, unique optimal downsample ratio r* can be found that determines how many pixels should be encoded in the base layer. Similarly for each sequence r_{∞} and β, r* are calculated and tabulated. FIG. 8 tabulates exemplary non-limiting optimal downsample ratios for several input video sequences according to particular non-limiting embodiments of the disclosed subject matter.

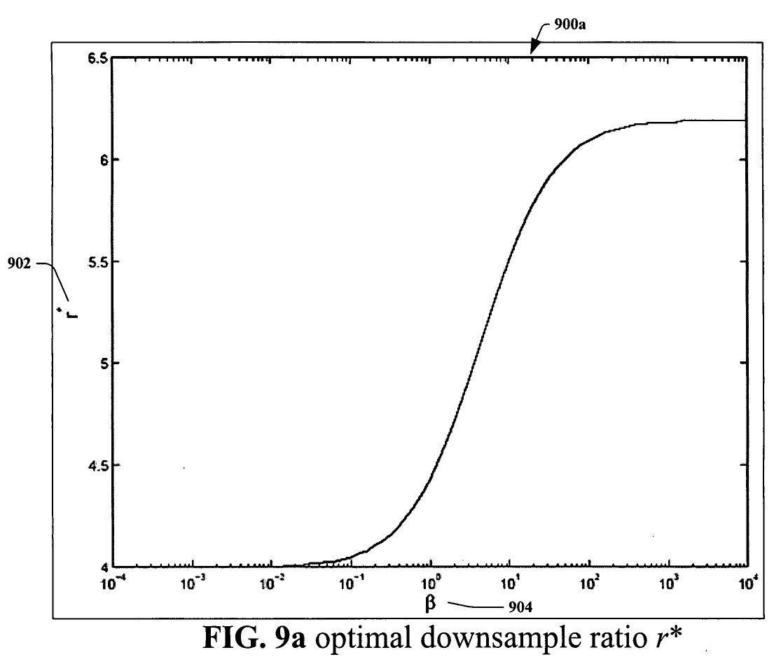

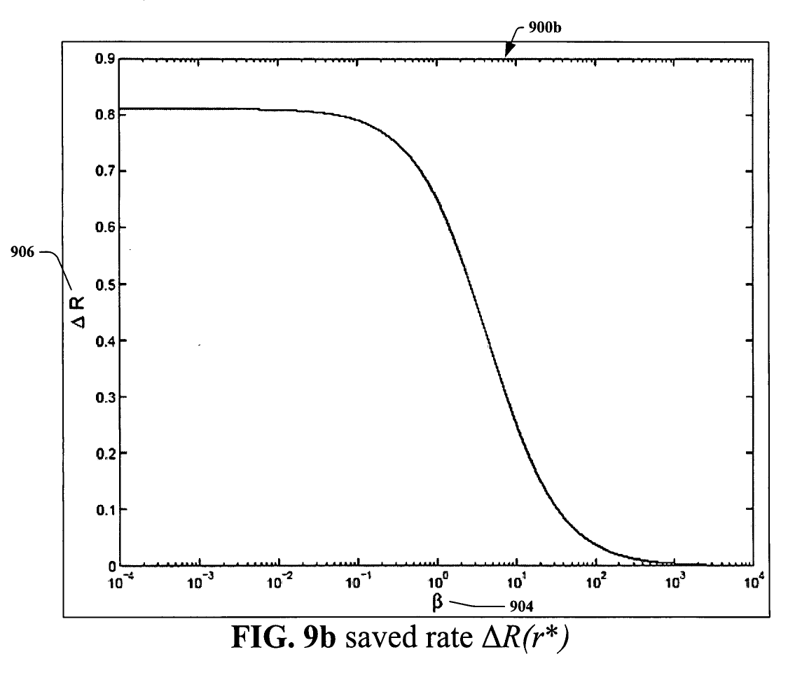

To illustrate the relationships, for r_{∞}=80.1, optimal r* 902 versus β 904 is numerically solved and plotted in FIG. 9a and FIG. 9b depicts saved rate ΔR(r*) 906 for r_{∞}=80.1 according to one aspect of the disclosed subject matter. In FIG. 9a, it can be observed that r* converge to 4.00 and 6.19 respectively when β tends toward 0 or infinity. The following explicit expression for these two marginal convergence values can be found:

$${r}^{*} = \{ \begin{matrix}L w ( {r}_{∞} e ) , & β \to 0 ; \\ {( \begin{matrix}{( \sqrt{{r}_{∞} + 1 / 27} + \sqrt{{r}_{∞}} )}^{\frac{1}{3}} - \\ {( \sqrt{{r}_{∞} + 1 / 27} + \sqrt{{r}_{∞}} )}^{\frac{1}{3}}\end{matrix} )}^{2} , & β \to ∞ .\end{matrix} \qquad ( 25 )$$

where Lw(.) denotes Lambert W-function. Corresponding rate savings are:

$$\begin{matrix}Δ {R}_{β -> 0} ( {r}^{*} ) = \frac{1}{4} ( 2 L ω ( {r}_{∞} e ) - \frac{1}{L ω ( {r}_{∞} e )} ) {log}_{2} e and & ( 26 ) \\ Δ {R}_{β -> ∞} ( {r}^{*} ) = 0 & ( 27 )\end{matrix}$$

For βε(0,∞), it is noted that ΔR(r,β) is monotonic decreasing function of β for each r. This yields the concave hull ΔR(r*,β), as a function of β, which is also monotonic decreasing. Therefore:

ΔR_{β→∞}(r*)<ΔR(r*,β)<ΔR_{β→0}(r*) (28)

Consistency of Eqns. (25), (26), (27), and (28) with the numerical result can be seen in FIGS. 9a-9b. Using Eqn. (25), the range of optimal downsample ratios can be conveniently calculated as shown in FIG. 8. Based on results in the table of FIG. 8, various embodiments of the disclosed subject matter as described use r=4.

### Multiple Layer Refinement

In this section, the coding efficiency analysis is extended to multiple stage refinement. For example, according to various non-limiting embodiments of the disclosed subject matter, the problem can be considered to encode the video by n-stages resolution refinement scheme, and in which at each layer

$$\frac{1}{n}$$

of pixels can be sent. Similar to single refinement, the rate distortion function can be expressed as:

$$\begin{matrix}{R}^{SR} ( D ) = {\sum }_{m = 0}^{n - 1} \frac{1}{n} \frac{1}{2} {log}_{2} ( \frac{{σ}_{m}^{2}}{D} ) where & ( 29 ) \\ {σ}_{0}^{2} = A \sqrt{{r}_{∞}} + N & ( 30 )\end{matrix}$$

denotes the residue variance of MCE/MCI prediction, and

$${σ}_{m}^{2} = A \sqrt{\frac{n}{m}} + N , m = 1 , 2 , … , n - 1 \qquad ( 31 )$$

are motion compensated residue variances after each refinement stage. The result in Eqn. (31) arises, because after m times transition, those

$$\frac{m}{n}$$

available pixels will be used to refine the motion, which means the downsample ratio is

$$r = \frac{n}{m}$$

and the residue variance can be approximated as

$$A \sqrt{\frac{n}{m}} + N .$$

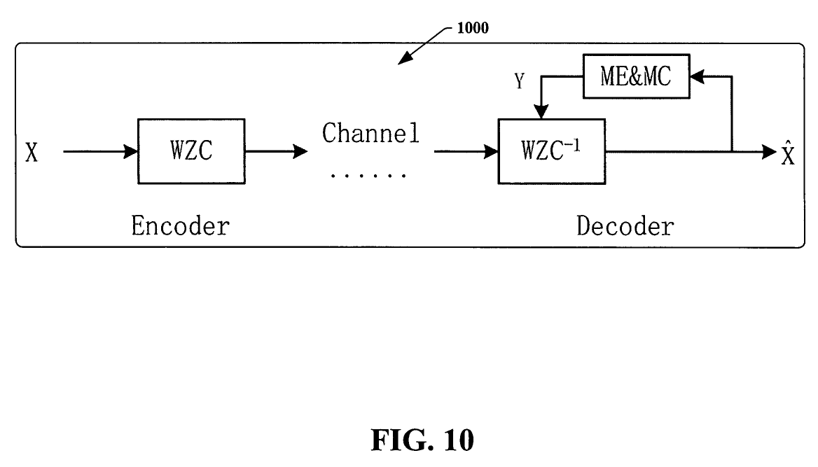

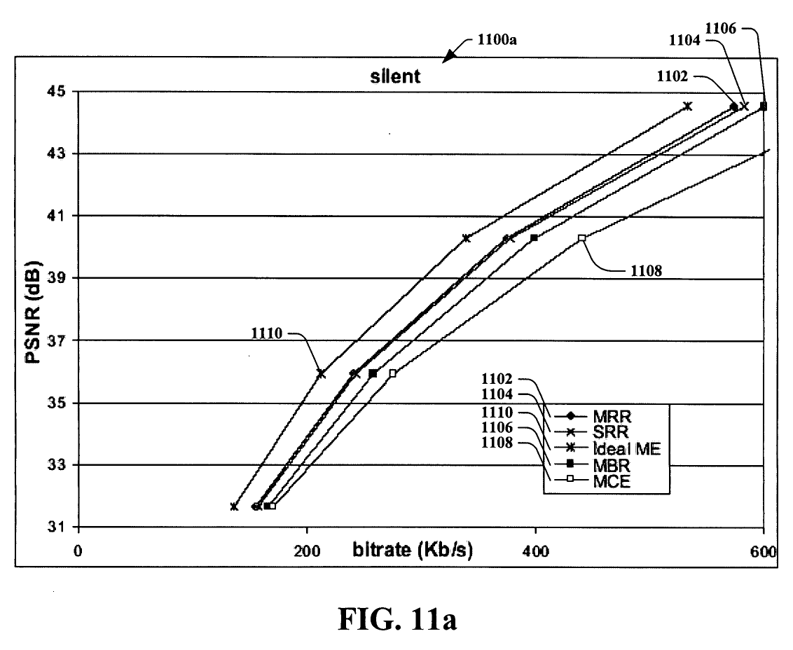

For comparison, consider the ideal system in FIG. 10, where side information can be generated through motion estimation using the decoder output. FIG. 10 illustrates an exemplary non-limiting block diagram of an ideal WZ video coding and decoding system with none-causal Motion Estimation (ME) for comparison of particular non-limiting embodiments of the disclosed subject matter. This system can approach traditional video coding system motion compensation accuracy. However, this system can be shown to be none-causal and is impractical. Nevertheless, its performance can be considered as an upper bound for any practical Wyner-Ziv video coding system. For this none-casual system, the rate distortion function can be represented as:

$$\begin{matrix}{R}^{WZ} ( D ) = \frac{1}{2} {log}_{2} ( \frac{{σ}^{2}}{D} ) where & ( 32 ) \\ {σ}^{2} = A + N & ( 33 )\end{matrix}$$

denotes residue variance when all pixels are used in motion estimation, e.g. when the downsample ratio r=1.

Now, with Eqns., (29) and (32) the following rate redundancy can be established:

$$Δ R = \frac{1}{n} \frac{1}{2} {log}_{2} ( \frac{\sqrt{{r}_{∞}} + β}{1 + β} ) + {\sum }_{m = 1}^{n - 1} \frac{1}{n} \frac{1}{2} {log}_{2} ( \frac{\sqrt{\frac{n}{m}} + β}{1 + β} ) \qquad ( 34 )$$

which is a monotonic decreasing function of β.

When β→∞, ΔR≈0;

When β→0, then:

$$Δ R \approx \frac{1}{4 n} {log}_{2} [ \frac{{n}^{n}}{( n - 1 ) !} ] \approx \frac{1}{4} {log}_{2} e ( bits / pixel ) = \frac{1}{4} ( nats / pixel ) \qquad ( 35 )$$

The result in Eqn. (35) comes from the Stirling formula and is already very tight when n≧8.

Therefore for βε(0,∞), then:

$$0 < Δ R ( {r}^{*} , β ) < \frac{1}{4} ( nats / pixel ) \qquad ( 36 )$$

Thus, it follows that the successive refinement scheme of the disclosed subject matter can approach ideal motion compensated Wyner-Ziv system very closely with only 0˜2.17 dB loss. Note again that the loss of original MCI/MCE based system can be up to 6 dB, which means successive refinement system can gain up to 4 dB over MCI/MCE based Wyner-Ziv system.

### B Frame

Similar to the analysis above for the ‘P’ frame, in B frame suppose x is the current frame, y₁ and y₂ are backward and forward reference frames respectively. Then, y₁(i₁,j₁)=x(i,j)+n₁(i,j) and y₂(i₂,j₂)=x(i,j)+n₂(i,j), where n₁(i,j) and n₂(i,j) denote systematic residue.

If backward and forward motion vectors have error Δ₁ and Δ₂ respectively, then the variance of practical residue e(i,j) will become:

$$\begin{matrix}{σ}_{e}^{2} = E \{ {( x ( i , j ) - \frac{1}{2} {y}_{1} ( ( {i}_{1} , {j}_{1} ) + {Δ}_{1} ) - \frac{1}{2} {y}_{2} ( ( {i}_{2} , {j}_{2} ) + {Δ}_{2} ) )}^{2} \} & ( 37 ) \\ = E \{ \frac{3}{2} {σ}_{x}^{2} + \frac{1}{2} {σ}_{n}^{2} - \frac{1}{2} {R}_{x} ( {Δ}_{1} - {Δ}_{2} ) - {R}_{x} ( {Δ}_{1} ) - {R}_{x} ( {Δ}_{2} ) \} & ( 38 ) \\ = - \frac{1}{2} {σ}_{x}^{2} E \{ 1 - {ρ}^{\vert {Δ}_{1} - {Δ}_{2} \vert} \} + {σ}_{x}^{2} E \{ 1 - {ρ}^{\vert {Δ}_{1} \vert} \} + {σ}_{x}^{2} E \{ 1 - {ρ}^{\vert {Δ}_{2} \vert} \} + \frac{1}{2} {σ}_{n}^{2} & ( 39 ) \\ \approx - \frac{1}{2} {σ}_{x}^{2} ( 1 - ρ ) E \{ \vert {Δ}_{1} - {Δ}_{2} \vert \} + {σ}_{x}^{2} ( 1 - ρ ) E \{ \vert {Δ}_{1} \vert \} + {σ}_{x}^{2} ( 1 - ρ ) E \{ \vert {Δ}_{2} \vert \} + \frac{1}{2} {σ}_{n}^{2} & ( 40 )\end{matrix}$$

where E{|Δ₁−Δ₂|}, E{|Δ₁|}, E{|Δ₂|} are all approximately proportional to horizontal downsample rₓ as well as vertical downsample ratio r_{y}, (e.g., proportional to the square root of downsample ratio r:E{|Δ₁|}≈a\sqrt{r}), which is also consistent with the results below. Thus, a similar linear relationship results:

σₑ²≈A\sqrt{r}+N (41)

Accordingly, this means that all the previous derivation for ‘P’ frame holds for ‘B’ frame, including the proof of the 2.17 dB bound. It can be observed that ‘B’ frames have larger loss than ‘P’ frames, although both of them satisfy this ‘2.17 dB’ upper bound. This result can be explained by the following analysis.

For ‘B’ frame:

$$\begin{matrix}\frac{A}{N} = \frac{- \frac{1}{2} {σ}_{x}^{2} E \{ 1 - {ρ}^{\vert {Δ}_{1} - {Δ}_{2} \vert} \} + {σ}_{x}^{2} E \{ 1 - {ρ}^{\vert {Δ}_{1} \vert} \} + {σ}_{x}^{2} E \{ 1 - {ρ}^{\vert {Δ}_{2} \vert} \}}{\frac{1}{2} {σ}_{n}^{2} \sqrt{r}} & ( 42 ) \\ \geq \frac{{σ}_{x}^{2} E \{ 3 - 2 {ρ}^{\vert {Δ}_{1} \vert} - 2 {ρ}^{\vert {Δ}_{2} \vert} + {ρ}^{\vert {Δ}_{1} \vert + \vert {Δ}_{2} \vert} \}}{{σ}_{n}^{2} \sqrt{r}} & ( 43 ) \\ = \frac{{σ}_{x}^{2} E \{ 3 - 3 {ρ}^{\vert {Δ}_{1} \vert} - {ρ}^{\vert {Δ}_{2} \vert} + {ρ}^{\vert {Δ}_{1} \vert + \vert {Δ}_{2} \vert} \}}{{σ}_{n}^{2} \sqrt{r}} & ( 44 ) \\ = \frac{{σ}_{x}^{2} E \{ ( 3 - {ρ}^{\vert {Δ}_{2} \vert} ) ( 1 - {ρ}^{\vert {Δ}_{1} \vert} ) \}}{{σ}_{n}^{2} \sqrt{r}} & ( 45 ) \\ \geq \frac{2 {σ}_{x}^{2} E \{ 1 - {ρ}^{\vert {Δ}_{1} \vert} \}}{{σ}_{n}^{2} \sqrt{r}} & ( 46 )\end{matrix}$$

while for ‘P’ frame:

$$\frac{A}{N} = \frac{2 {σ}_{x}^{2} E \{ 1 - {ρ}^{\vert Δ \vert} \}}{{σ}_{n}^{2} \sqrt{r}} \qquad ( 47 )$$

which means ‘B’ frames have smaller β

$$β = \frac{N}{A}$$

than ‘P’ frame, because Δ₁ and Δ satisfy the same i.i.d. criteria. Accordingly, because Eqn. (34) is a monotonic decreasing function, this illustrates why ‘B’ frames have larger rate redundancy.

### Calculation Complexity

Compared with conventional Wyner-Ziv coding schemes (e.g., compression schemes), according to various non-limiting embodiments of the disclosed subject matter, at the encoder, successive refinement of the disclosed subject matter only changes the sending order of bitplanes. Accordingly, the various non-limiting embodiments of the disclosed subject matter can be expected to have substantially similar encoder complexity relative to conventional encoders.

At the decoder, it can be shown that the complexity difference is mainly due to motion estimation. Advantageously, in the resolution refinement schemes of the disclosed subject matter, SADs are only calculated and accumulated for those new decoded pixels at each stage. As a result, the disclosed subject matter requires substantially the same amount of SAD calculation with more SAD comparison complexity. In contrast, the bitplane refinement scheme motion estimation complexity is much higher, because n-bitplane refinement systems will perform n times motion estimation and each has full complexity.

WZSR Video Compression Results

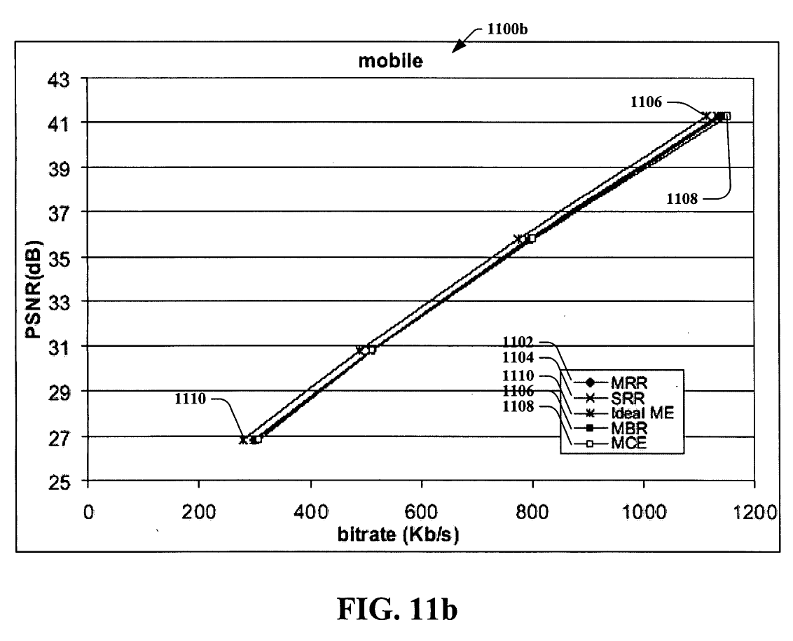

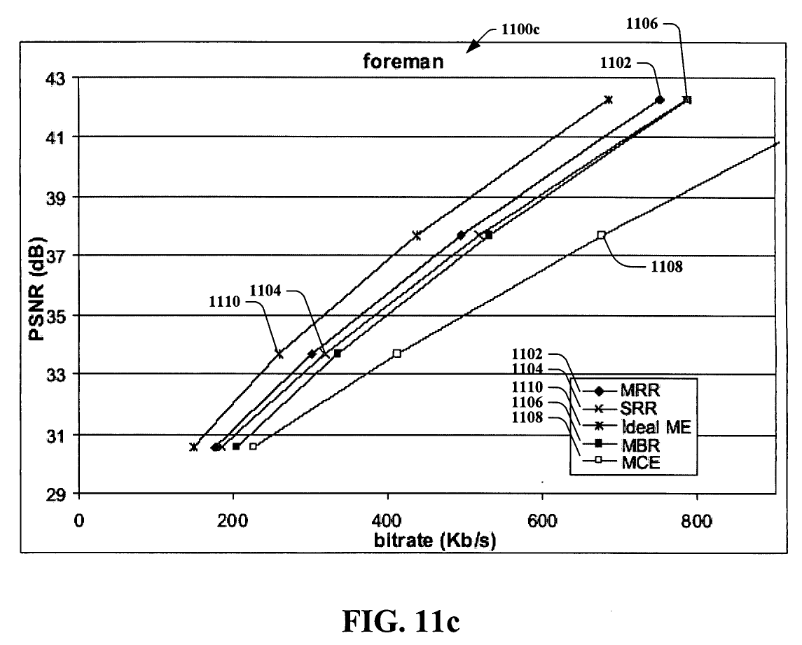

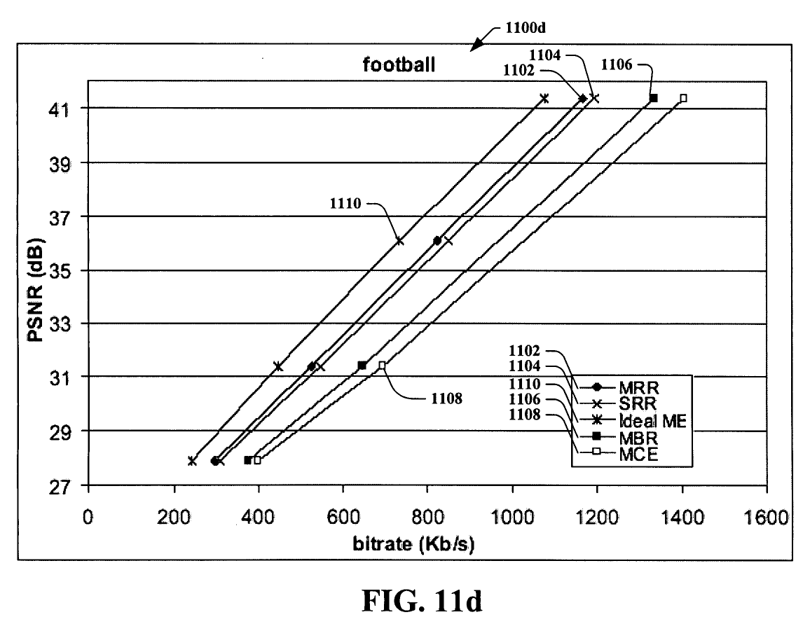

Rate distortion and complexity are compared in FIGS. 11a-11d below for five approaches (e.g., a particular non-limiting embodiment of the multistage resolution refinement approach (MRR) 1102 of the disclosed subject matter, a particular non-limiting embodiment of the single resolution refinement approach (SRR) 1104 of the disclosed subject matter, multistage bitplane refinement approach (MBR) 1106, MCE/MCI based Wyner-Ziv conventional approach (MCE) 1108, and the ideal none-casual motion estimation approach (NC or Ideal ME)) 1110. In SRR, ¼ pixels are compressed at base layer according to 4-Queen downsample pattern.

The results show typical Quarter Common Intermediate Format (QCIF) used for distributed video coding performance analysis. Both P frame and B frame are implemented and compared, with 8×8 block motion estimation. The LDPCA code is generated, for example, for input block length 3168, based on the density function:

λ(x)=0.321x²+0.456x³+0.010x⁶+0.174x⁷+0.039x⁸ (48)

LDPC decoder can be assumed to be capable of output error detection and, thus, can facilitate taking an action of requesting more bits from the encoder through a feedback channel.

### P Frame Result

P frame tests focus on low delay low complexity systems, where only one previous frame is used as reference at the decoder. Test sequences are the first 100 frames of each QCIF sequence at 15 Hz. The first frame is encoded by H.263+, while following 99 frames are encoded by the subject Wyner-Ziv approaches.

Accordingly, FIGS. 11a-d depict exemplary non-limiting comparative Rate-Distortion (RD) performance for P frame, QCIF at 15 Hz, for several input video sequences according to particular non-limiting embodiments of the disclosed subject matter. It can be seen that, none-casual motion estimation 1110 (NC or Ideal ME) performs the best while MCE 1108 approach performs the worst as can be expected. The particular embodiment of the MRR approach 1102 performs 0˜2.8 dB better than MBR approach 1106, and 0˜3.7 dB better than MCE approach 1108. The performance the particular embodiment of the SRR approach 1104 lies between the MRR 1102 and MBR 106 approaches. Gaps between all curves are large for high motion video sequence (e.g. FIG. 11c, ‘foreman’, and FIG. 11d, ‘football’), and are very small for low motion video such as in FIG. 11b, ‘mobile’. Compared to the none-casual approach 1110 (NC or Ideal ME), the particular embodiment of the MRR approach 1102 lost at most 1.5 dB for all sequences, which is consistent with derived 2.17 dB upper bound.

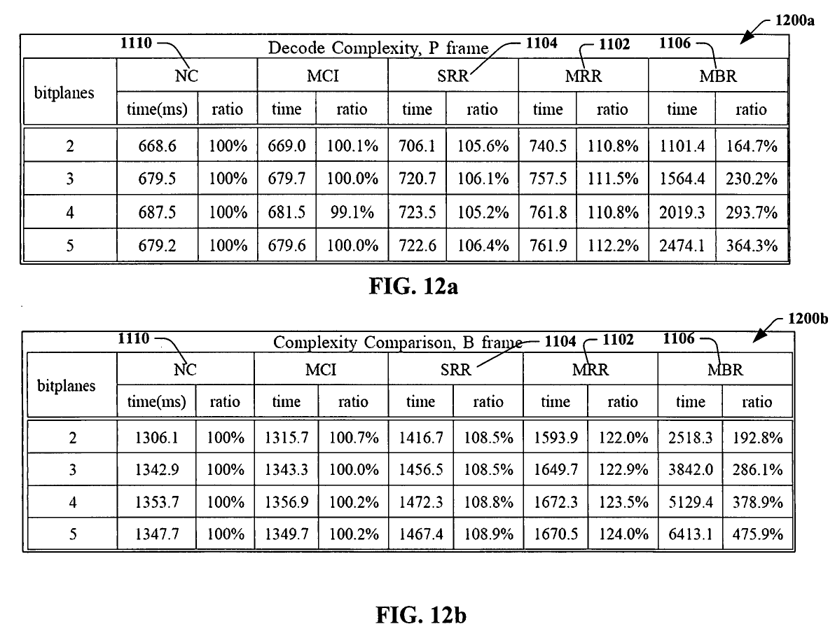

As to complexity at the encoder, all the successive refinement approaches have substantially the same low complexity as original MCE based Wyner-Ziv approach. At the decoder, the SRR 1104 and MRR 1102 approaches of the disclosed subject matter have similar complexity with original MCE based Wyner-Ziv approach, because SADs for lower layers can be reused by higher layers. However, for the MBR approach 1106, the complexity increases proportionally to the number of bitplanes. FIGS. 12a-b depict exemplary non-limiting comparative decoder complexity for P frame and B frame according to particular non-limiting embodiments of the disclosed subject matter as described above. Average decoder complexities for the P frame implementation are compared in FIG. 12a, where SWC decoding time has been excluded because it varies substantially depending on specific channel codes.

### B Frame

In B frame tests, the decoder is allowed to use the average of two adjacent reference frames as prediction. The first 101 frames of QCIF sequences at 7.5 Hz are used as test sequences. First frame is encoded by H.263+, and other 50 odd frames are encoded by MCE based P frame Wyner-Ziv encoder, and even frames are encoded by B frame Wyner-Ziv approaches.

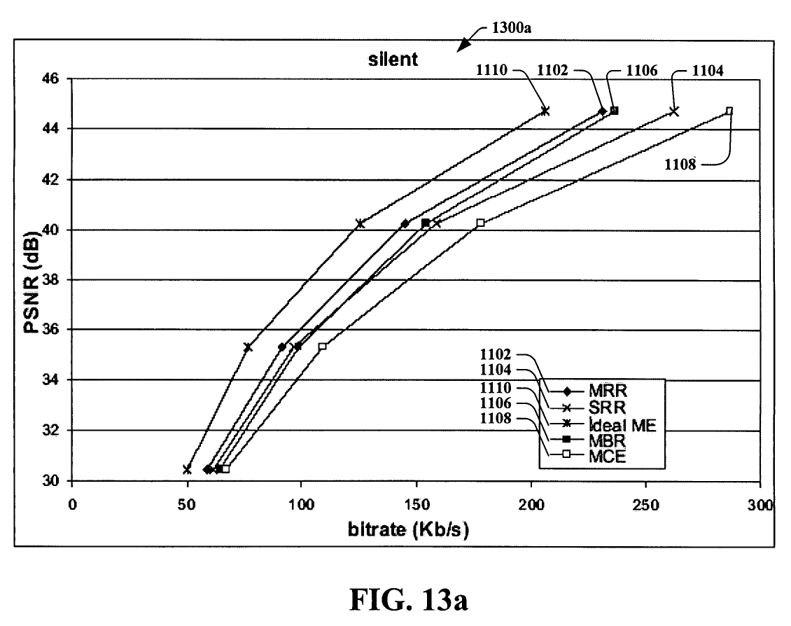

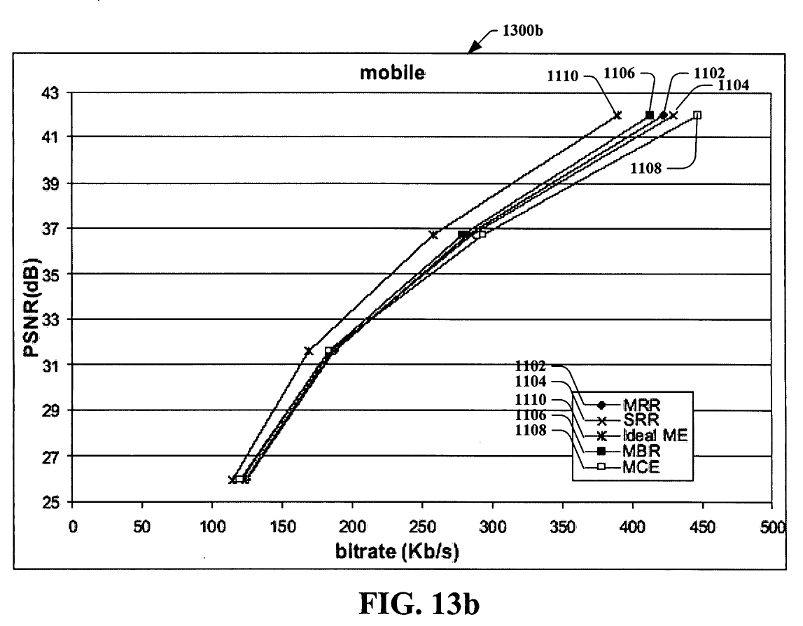

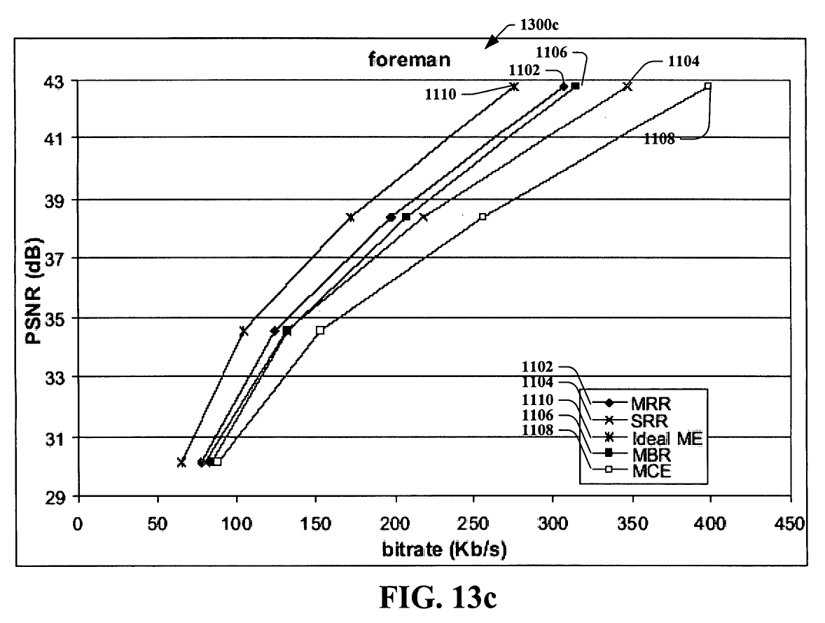

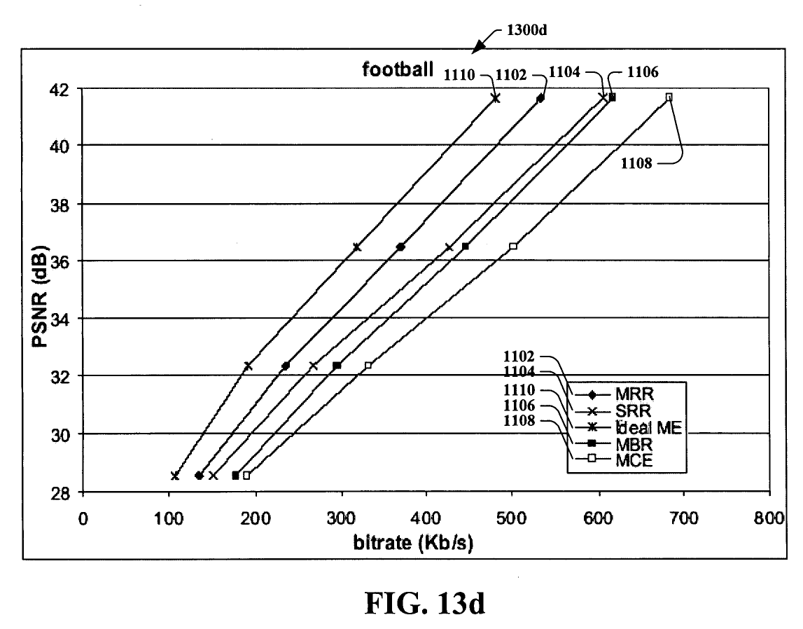

FIGS. 13a-d depict exemplary non-limiting comparative Rate-Distortion (RD) performance for the B frame, QCIF at 7.5 Hz, for several input video sequences according to particular non-limiting embodiments of the disclosed subject matter. The five approaches share same P frame reconstruction as reference for B frame. Thus, only bitrate and distortion for B frame are plotted. The relationship between each curve is similar to previous P frame results, except that MBR approach 1106 becomes better than SRR approach 1104 in some sequences. The particular embodiment of the MRR approach 1102 outperforms MBR approach 1106 in most sequences, and gains more than 2 dB at ‘football’ (in FIG. 13d). Compared with original MCE based Wyner-Ziv system 1108, the particular embodiment of the MRR approach 1102 gains 1˜4.5 dB at high bitrate and 0˜2 dB at low bitrate. Similar to previous P frame results, gaps between all the methods become larger for high motion video (e.g. FIG. 11c, ‘foreman’, and FIG. 13d, ‘football’). The gap between the particular embodiment of the MRR approach 1102 and none-casual system 1110 (NC or Ideal ME) still remain less than 2 dB which is consistent with our 2.17 dB upper bound. However, it can be observed that the gap becomes larger than the gap in the P frame results, as consistent with the above analysis.

Average decoder complexities for exemplary non-limiting embodiments of the disclosed subject matter are depicted in FIG. 12b. SRR 1104 and MRR 1102 approaches of the disclosed subject matter keep similar complexity with original MCI based Wyner-Ziv approach, and MBR approach 1106 increases in complexity proportionally with the number of bitplanes. It is noted that the MRR approach 1102 of the disclosed subject matter becomes slightly more complicated than SRR 1104, because of the higher amount averaging operations required.

### Exemplary Video Stream Processing System

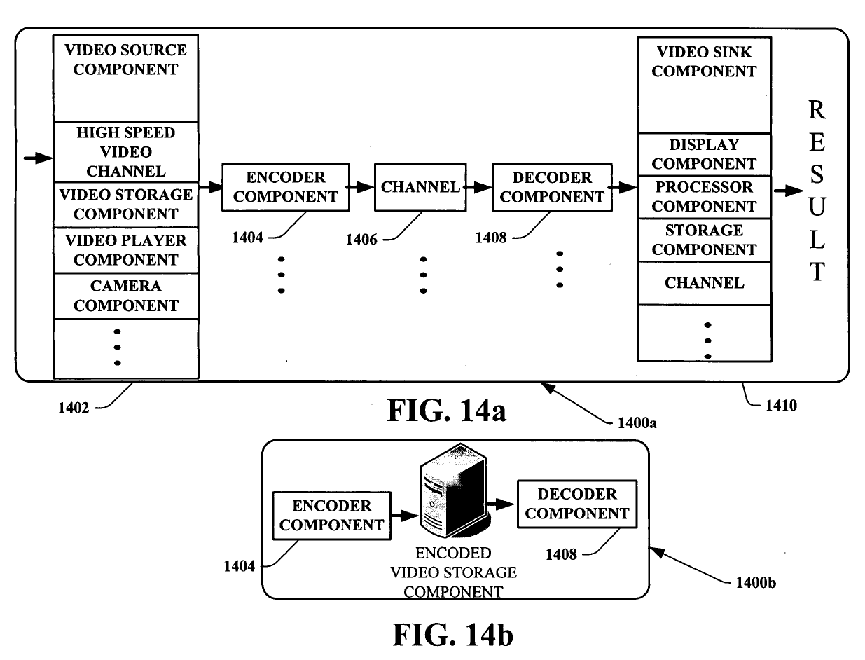

FIG. 14 is a block diagram of an exemplary non-limiting embodiment of a video coding and decoding system 1400a and 1400b suitable for practicing the disclosed subject matter. The system accepts video data from any number of source components 1402, encodes it using an encoder component 1404 such that the video data is encoded for transport or storage. System 1400a includes a decoder component 1408 that receives the transported or stored video data and decodes it for use by any number of video sink components.

In a basic operation, video data, typically unencoded video data, is provided to encoder component 1404, which encodes the video data, typically to form compressed video data that occupies fewer bits than the uncompressed video data, which then makes the compressed video data available to the decoder component (via a channel 1406, storage component, or a combination thereof). The decoder component 1408 in turn decompresses the compressed video data produce a substantially exact or approximate representation of the uncompressed video data provided to the input of the encoder component 1404. It should be understood that encoder component 1404 and decoder component 1408 of FIG. 14 can be implemented according to the disclosed subject matter as described above, and as further described below.

Video source components can include, for example, include a high-speed video channel (e.g., a cable or broadcast link capable of transmitting unencoded or partially encoded video data, video storage component (e.g., storage of unencoded or partially encoded video data), a camera component, or a video player component (e.g., a VCR or DVD player. Possible video sinks, for example, could include a display component (e.g., a monitor, television, a device LCD screen), a video processor component (e.g. video capture device, video processor algorithms operating on a special or general purpose processor, video editing device), video storage component that can store encoded or decoded video data, or another channel for subsequent transmission.

FIG. 14a illustrates an example 1400a where video is encoded for transmission over a channel 1406. By way of example channel 1406, could be a digital subscriber line (DSL), a cable modem, a dialup connection, broadcast, cable broadcast, satellite transmission, 802.11 Wireless link, cellular phone data network, internal signal bus, direct cable link (e.g., USB or IEEE-1394 or FIREWIRE link, and the like), or any other link (e.g., wired or wireless) suitable for the transmission of video data. In such cases, the video is encoded so that it can be transmitted using available bandwidth efficiently. For the purpose of the disclosed subject matter, the channel 1406 is subject to conditions presumed to cause frame loss transmission errors, which can be concealed using the disclosed systems and methods.

FIG. 14b illustrates an example of a system 1400b where video is encoded for storage. As shown, encoder 1404 encodes video data for storage in encoded video storage component for later retrieval by decoder 1408. The encoded video storage component can take any suitable form of sufficient capacity (e.g. a memory card, a personal video recorder (PVR), a hard disk drive, RAM, DVD, CD, or any other suitable storage).

It is to be understood that the coding and decoding system is illustrated generally to understand the basic operation of the disclosed subject matter. As such, the system depiction should not be viewed as limiting the disclosed subject matter as claimed. Further to the point and as more fully described below, although components are shown on the figures as discrete blocks, any number of such components can be combined into a single device, integrated into a single multi-function chip, or distributed across multiple local or remote devices as the designer desires or as the system architecture requires without changing the nature and operation of the claimed invention.

### Exemplary Networked and Distributed Environments

One of ordinary skill in the art can appreciate that the disclosed subject matter can be implemented in connection with any computer or other client or server device, which can be deployed as part of a computer network, or in a distributed computing environment, connected to any kind of data store. In this regard, the disclosed subject matter pertains to any computer system or environment having any number of memory or storage units, and any number of applications and processes occurring across any number of storage units or volumes, which can be used in connection with Wyner-Ziv Successive Refinement Video Compression systems and methods in accordance with the disclosed subject matter. The disclosed subject matter can apply to an environment with server computers and client computers deployed in a network environment or a distributed computing environment, having remote or local storage. The disclosed subject matter can also be applied to standalone computing devices, having programming language functionality, interpretation and execution capabilities for generating, receiving and transmitting information in connection with remote or local services and processes. Digital video processing, and thus the techniques for Wyner-Ziv Successive Refinement Video Compression in accordance with the disclosed subject matter can be applied with great efficacy in those environments.

Distributed computing provides sharing of computer resources and services by exchange between computing devices and systems. These resources and services include the exchange of information, cache storage and disk storage for objects, such as files. Distributed computing takes advantage of network connectivity, allowing clients to leverage their collective power to benefit the entire enterprise. In this regard, a variety of devices can have applications, objects or resources that may implicate the systems and methods for Wyner-Ziv Successive Refinement Video Compression of the disclosed subject matter.

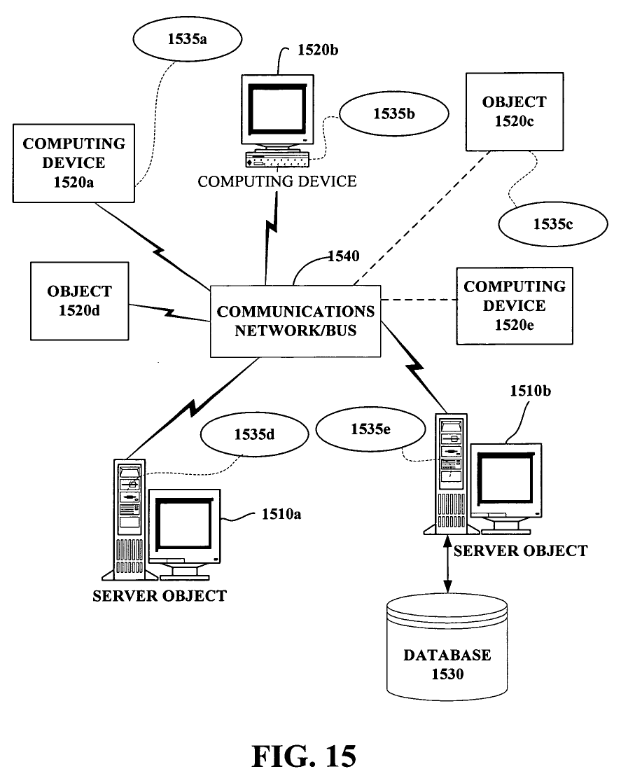

FIG. 15 provides a schematic diagram of an exemplary networked or distributed computing environment. The distributed computing environment comprises computing objects 1510a, 1510b, etc. and computing objects or devices 1520a, 1520b, 1520c, 1520d, 1520e, etc. These objects can comprise programs, methods, data stores, programmable logic, etc. The objects can comprise portions of the same or different devices such as PDAs, audio/video devices, MP3 players, personal computers, etc. Each object can communicate with another object by way of the communications network 1540. This network can itself comprise other computing objects and computing devices that provide services to the system of FIG. 15, and can itself represent multiple interconnected networks. In accordance with an aspect of the disclosed subject matter, each object 1510a, 1510b, etc. or 1520a, 1520b, 1520c, 1520d, 1520e, etc. can contain an application that might make use of an API, or other object, software, firmware and/or hardware, suitable for use with the systems and methods for Wyner-Ziv Successive Refinement Video Compression in accordance with the disclosed subject matter.

It can also be appreciated that an object, such as 1520c, can be hosted on another computing device 1510a, 1510b, etc. or 1520a, 1520b, 1520c, 1520d, 1520e, etc. Thus, although the physical environment depicted can show the connected devices as computers, such illustration is merely exemplary and the physical environment can alternatively be depicted or described comprising various digital devices such as PDAs, televisions, MP3 players, etc., any of which can employ a variety of wired and wireless services, software objects such as interfaces, COM objects, and the like.

There are a variety of systems, components, and network configurations that support distributed computing environments. For example, computing systems can be connected together by wired or wireless systems, by local networks or widely distributed networks. Currently, many of the networks are coupled to the Internet, which provides an infrastructure for widely distributed computing and encompasses many different networks. Any of the infrastructures can be used for exemplary communications made incident to Wyner-Ziv Successive Refinement Video Compression according to the disclosed subject matter.

In home networking environments, there are at least four disparate network transport media that can each support a unique protocol, such as Power line, data (both wireless and wired), voice (e.g., telephone) and entertainment media. Most home control devices such as light switches and appliances can use power lines for connectivity. Data Services can enter the home as broadband (e.g., either DSL or Cable modem) and are accessible within the home using either wireless (e.g. HomeRF or 802.11B) or wired (e.g., Home PNA, Cat 5, Ethernet, even power line) connectivity. Voice traffic can enter the home either as wired (e.g. Cat 3) or wireless (e.g., cell phones) and can be distributed within the home using Cat 3 wiring. Entertainment media, or other graphical data, can enter the home either through satellite or cable and is typically distributed in the home using coaxial cable. IEEE 1394 and DVI are also digital interconnects for clusters of media devices. All of these network environments and others that may emerge, or already have emerged, as protocol standards can be interconnected to form a network, such as an intranet, that can be connected to the outside world by way of a wide area network, such as the Internet. In sum, a variety of disparate sources exist for the storage and transmission of data, and consequently, any of the computing devices of the disclosed subject matter may share and communicate data in any existing manner, and no one way described in the embodiments herein is intended to be limiting.

The Internet commonly refers to the collection of networks and gateways that utilize the Transmission Control Protocol/Internet Protocol (TCP/IP) suite of protocols, which are well-known in the art of computer networking. The Internet can be described as a system of geographically distributed remote computer networks interconnected by computers executing networking protocols that allow users to interact and share information over network(s). Because of such wide-spread information sharing, remote networks such as the Internet have thus far generally evolved into an open system with which developers can design software applications for performing specialized operations or services, essentially without restriction.

Thus, the network infrastructure enables a host of network topologies such as client/server, peer-to-peer, or hybrid architectures. The “client” is a member of a class or group that uses the services of another class or group to which it is not related. Thus, in computing, a client is a process, e.g., roughly a set of instructions or tasks, that requests a service provided by another program. The client process utilizes the requested service without having to “know” any working details about the other program or the service itself. In a client/server architecture, particularly a networked system, a client is usually a computer that accesses shared network resources provided by another computer, e.g. a server. In the illustration of FIG. 15, as an example, computers 1520a, 1520b, 1520c, 1520d, 1520e, etc. can be thought of as clients and computers 1510a, 1510b, etc. can be thought of as servers where servers 1510a, 1510b, etc. maintain the data that is then replicated to client computers 1520a, 1520b, 1520c, 1520d, 1520e, etc., although any computer can be considered a client, a server, or both, depending on the circumstances. Any of these computing devices may be processing data or requesting services or tasks that can implicate the Wyner-Ziv Successive Refinement Video Compression systems and methods in accordance with the disclosed subject matter.

A server is typically a remote computer system accessible over a remote or local network, such as the Internet or wireless network infrastructures. The client process can be active in a first computer system, and the server process can be active in a second computer system, communicating with one another over a communications medium, thus providing distributed functionality and allowing multiple clients to take advantage of the information-gathering capabilities of the server. Any software objects utilized pursuant to the techniques for Wyner-Ziv Successive Refinement Video Compression of the disclosed subject matter can be distributed across multiple computing devices or objects.

Client(s) and server(s) communicate with one another utilizing the functionality provided by protocol layer(s). For example, HyperText Transfer Protocol (HTTP) is a common protocol that is used in conjunction with the World Wide Web (WWW), or “the Web.” Typically, a computer network address such as an Internet Protocol (IP) address or other reference such as a Universal Resource Locator (URL) can be used to identify the server or client computers to each other. The network address can be referred to as a URL address. Communication can be provided over a communications medium, e.g. client(s) and server(s) can be coupled to one another via TCP/IP connection(s) for high-capacity communication.

Thus, FIG. 15 illustrates an exemplary networked or distributed environment, with server(s) in communication with client computer (s) via a network/bus, in which the disclosed subject matter can be employed. In more detail, a number of servers 1510a, 1510b, etc. are interconnected via a communications network/bus 1540, which can be a LAN, WAN, intranet, GSM network, the Internet, etc., with a number of client or remote computing devices 1520a, 1520b, 1520c, 1520d, 1520e, etc., such as a portable computer, handheld computer, thin client, networked appliance, or other device, such as a VCR, TV, oven, light, heater and the like in accordance with the disclosed subject matter. It is thus contemplated that the disclosed subject matter can apply to any computing device in connection with which it is desirable to code and/or decode video according to the disclosed compression systems and methods.

In a network environment in which the communications network/bus 1540 is the Internet, for example, the servers 1510a, 1510b, etc. can be Web servers with which the clients 1520a, 1520b, 1520c, 1520d, 1520e, etc. communicate via any of a number of known protocols such as HTTP. Servers 1510a, 1510b, etc. can also serve as clients 1520a, 1520b, 1520c, 1520d, 1520e, etc., as can be characteristic of a distributed computing environment.

As mentioned, communications can be wired or wireless, or a combination, where appropriate. Client devices 1520a, 1520b, 1520c, 1520d, 1520e, etc. may or may not communicate via communications network/bus 15, and can have independent communications associated therewith. For example, in the case of a TV or VCR, there may or may not be a networked aspect to the control thereof. Each client computer 1520a, 1520b, 1520c, 1520d, 1520e, etc. and server computer 1510a, 1510b, etc. can be equipped with various application program modules or objects 135a, 135b, 135c, etc. and with connections or access to various types of storage elements or objects, across which files or data streams can be stored or to which portion(s) of files or data streams can be downloaded, transmitted or migrated. Any one or more of computers 1510a, 1510b, 1520a, 1520b, 1520c, 1520d, 1520e, etc. can be responsible for the maintenance and updating of a database 1530 or other storage element, such as a database or memory 1530 for storing data processed or saved according to the disclosed subject matter. Thus, the disclosed subject matter can be utilized in a computer network environment having client computers 1520a, 1520b, 1520c, 1520d, 1520e, etc. that can access and interact with a computer network/bus 1540 and server computers 1510a, 1510b, etc. that may interact with client computers 1520a, 1520b, 1520c, 1520d, 1520e, etc. and other like devices, and databases 1530.

### Exemplary Computing Device

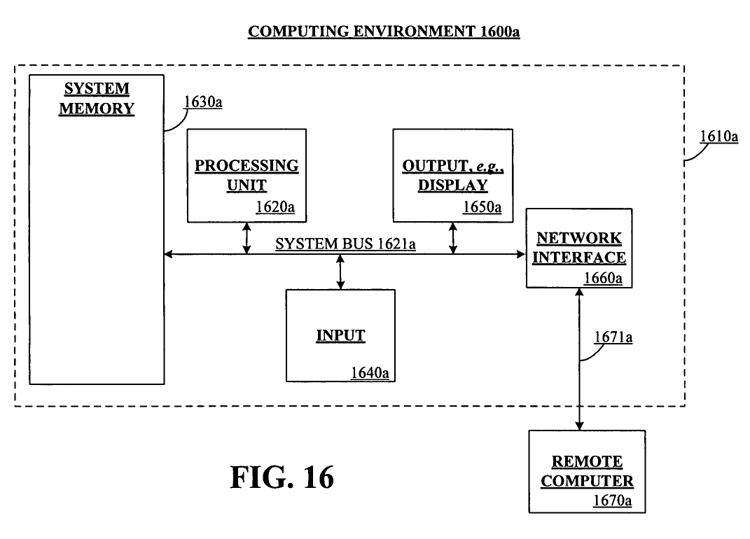

As mentioned, the disclosed subject matter applies to any device wherein it can be desirable to compress and decompress video. It should be understood, therefore, that handheld, portable and other computing devices and computing objects of all kinds are contemplated for use in connection with the disclosed subject matter, i.e., anywhere that a device can receive or otherwise process or store data video data. Accordingly, the below general purpose remote computer described below in FIG. 16 is but one example, and the disclosed subject matter can be implemented with any client having network/bus interoperability and interaction. Thus, the disclosed subject matter can be implemented in an environment of networked hosted services in which very little or minimal client resources are implicated, e.g. a networked environment in which the client device serves merely as an interface to the network/bus, such as an object placed in an appliance.

Although not required, the disclosed subject matter can partly be implemented via an operating system, for use by a developer of services for a device or object, and/or included within application software that operates in connection with the component(s) of the disclosed subject matter. Software can be described in the general context of computer executable instructions, such as program modules, being executed by one or more computers, such as client workstations, servers or other devices. Those skilled in the art will appreciate that the disclosed subject matter can be practiced with other computer system configurations and protocols.

FIG. 16 thus illustrates an example of a suitable computing system environment 1600a in which the disclosed subject matter can be implemented, although as made clear above, the computing system environment 1600a is only one example of a suitable computing environment for a media device and is not intended to suggest any limitation as to the scope of use or functionality of the disclosed subject matter. Neither should the computing environment 1600a be interpreted as having any dependency or requirement relating to any one or combination of components illustrated in the exemplary operating environment 1600a.

With reference to FIG. 16, an exemplary remote device for implementing the disclosed subject matter includes a general purpose computing device in the form of a computer 1610a. Components of computer 1610a can include, but are not limited to, a processing unit 1620a, a system memory 1630a, and a system bus 1621a that couples various system components including the system memory to the processing unit 1620a. The system bus 1621a can be any of several types of bus structures including a memory bus or memory controller, a peripheral bus, and a local bus using any of a variety of bus architectures.

Computer 1610a typically includes a variety of computer readable media. Computer readable media can be any available media that can be accessed by computer 1610a. By way of example, and not limitation, computer readable media can comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CDROM, digital versatile disks (DVD) or other optical disk storage, magnetic cassettes, magnetic tape, magnetic disk storage or other magnetic storage devices, or any other medium which can be used to store the desired information and which can be accessed by computer 1610a. Communication media typically embodies computer readable instructions, data structures, program modules or other data in a modulated data signal such as a carrier wave or other transport mechanism and includes any information delivery media.

The system memory 1630a can include computer storage media in the form of volatile and/or nonvolatile memory such as read only memory (ROM) and/or random access memory (RAM). A basic input/output system (BIOS), containing the basic routines that help to transfer information between elements within computer 1610a, such as during start-up, can be stored in memory 1630a. Memory 1630a typically also contains data and/or program modules that are immediately accessible to and/or presently being operated on by processing unit 1620a. By way of example, and not limitation, memory 1630a can also include an operating system, application programs, other program modules, and program data.

The computer 1610a can also include other removable/non-removable, volatile/nonvolatile computer storage media. For example, computer 1610a could include a hard disk drive that reads from or writes to non-removable, nonvolatile magnetic media, a magnetic disk drive that reads from or writes to a removable, nonvolatile magnetic disk, and/or an optical disk drive that reads from or writes to a removable, nonvolatile optical disk, such as a CD-ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM and the like. A hard disk drive is typically connected to the system bus 1621a through a non-removable memory interface such as an interface, and a magnetic disk drive or optical disk drive is typically connected to the system bus 1621a by a removable memory interface, such as an interface.

A user can enter commands and information into the computer 1610a through input devices such as a keyboard and pointing device, commonly referred to as a mouse, trackball or touch pad. Other input devices can include a microphone, joystick, game pad, satellite dish, scanner, or the like. These and other input devices are often connected to the processing unit 1620a through user input 1640a and associated interface(s) that are coupled to the system bus 1621a, but can be connected by other interface and bus structures, such as a parallel port, game port or a universal serial bus (USB). A graphics subsystem can also be connected to the system bus 1621a. A monitor or other type of display device is also connected to the system bus 1621a via an interface, such as output interface 1650a, which can in turn communicate with video memory. In addition to a monitor, computers can also include other peripheral output devices such as speakers and a printer, which can be connected through output interface 1650a.

The computer 1610a can operate in a networked or distributed environment using logical connections to one or more other remote computers, such as remote computer 1670a, which can in turn have media capabilities different from device 1610a. The remote computer 1670a can be a personal computer, a server, a router, a network PC, a peer device or other common network node, or any other remote media consumption or transmission device, and can include any or all of the elements described above relative to the computer 1610a. The logical connections depicted in FIG. 16 include a network 1671a, such local area network (LAN) or a wide area network (WAN), but can also include other networks/buses. Such networking environments are commonplace in homes, offices, enterprise-wide computer networks, intranets and the Internet.

When used in a LAN networking environment, the computer 1610a is connected to the LAN 1671a through a network interface or adapter. When used in a WAN networking environment, the computer 1610a typically includes a communications component, such as a modem, or other means for establishing communications over the WAN, such as the Internet. A communications component, such as a modem, which can be internal or external, can be connected to the system bus 1621a via the user input interface of input 1640a, or other appropriate mechanism. In a networked environment, program modules depicted relative to the computer 1610a, or portions thereof, can be stored in a remote memory storage device. It will be appreciated that the network connections shown and described are exemplary and other means of establishing a communications link between the computers can be used.

### Exemplary Distributed Computing Architectures

Various distributed computing frameworks have been and are being developed in light of the convergence of personal computing and the Internet. Individuals and business users alike are provided with a seamlessly interoperable and Web-enabled interface for applications and computing devices, making computing activities increasingly Web browser or network-oriented.

For example, MICROSOFT®'s managed code platform, i.e., .NET, includes servers, building-block services, such as Web-based data storage and downloadable device software. Generally speaking, the .NET platform provides (1) the ability to make the entire range of computing devices work together and to have user information automatically updated and synchronized on all of them, (2) increased interactive capability for Web pages, enabled by greater use of XML rather than HTML, (3) online services that feature customized access and delivery of products and services to the user from a central starting point for the management of various applications, such as e-mail, for example, or software, such as Office .NET, (4) centralized data storage, which increases efficiency and ease of access to information, as well as synchronization of information among users and devices, (5) the ability to integrate various communications media, such as e-mail, faxes, and telephones, (6) for developers, the ability to create reusable modules, thereby increasing productivity and reducing the number of programming errors and (7) many other cross-platform and language integration features as well.

While some exemplary embodiments herein are described in connection with software, such as an application programming interface (API), residing on a computing device, one or more portions of the disclosed subject matter can also be implemented via an operating system, or a “middle man” object, a control object, hardware, firmware, intermediate language instructions or objects, etc., such that the methods for Successive Refinement Video Compression in accordance with the disclosed subject matter can be included in, supported in or accessed via all of the languages and services enabled by managed code, such as .NET code, and in other distributed computing frameworks as well.

There are multiple ways of implementing the disclosed subject matter, e.g., an appropriate API, tool kit, driver code, operating system, control, standalone or downloadable software object, etc. which enables applications and services to use the systems and methods for Wyner-Ziv Successive Refinement Video Compression of the disclosed subject matter. The disclosed subject matter contemplates the use of the disclosed subject matter from the standpoint of an API (or other software object), as well as from a software or hardware object that performs video coding and decoding in accordance with the disclosed subject matter. Thus, various implementations of the disclosed subject matter described herein can have aspects that are wholly in hardware, partly in hardware and partly in software, as well as in software.

The word “exemplary” is used herein to mean serving as an example, instance, or illustration. For the avoidance of doubt, the subject matter disclosed herein is not limited by such examples. In addition, any aspect or design described herein as “exemplary” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, for the avoidance of doubt, such terms are intended to be inclusive in a manner similar to the term “comprising” as an open transition word without precluding any additional or other elements.

As mentioned above, while exemplary embodiments of the disclosed subject matter have been described in connection with various computing devices and network architectures, the underlying concepts can be applied to any computing device or system in which it is desirable to code and decode video. For instance, the systems and methods of the disclosed subject matter can be applied to the operating system of a computing device, provided as a separate object on the device, as part of another object, as a reusable control, as a downloadable object from a server, as a “middle man” between a device or object and the network, as a distributed object, as hardware, in memory, a combination of any of the foregoing, etc. While exemplary programming languages, names and examples are chosen herein as representative of various choices, these languages, names and examples are not intended to be limiting. One of ordinary skill in the art will appreciate that there are numerous ways of providing object code and nomenclature that achieves the same, similar or equivalent functionality achieved by the various embodiments of the disclosed subject matter.

As mentioned, the various techniques described herein can be implemented in connection with hardware or software or, where appropriate, with a combination of both. As used herein, the terms “component,” “system” and the like are likewise intended to refer to a computer-related entity, either hardware, a combination of hardware and software, software, or software in execution. For example, a component can be, but is not limited to being, a process running on a processor, a processor, an object, an executable, a thread of execution, a program, and/or a computer. By way of illustration, both an application running on computer and the computer can be a component. One or more components can reside within a process and/or thread of execution and a component can be localized on one computer and/or distributed between two or more computers.

Thus, the methods and apparatus of the disclosed subject matter, or certain aspects or portions thereof, can take the form of program code (i.e., instructions) embodied in tangible media, such as floppy diskettes, CD-ROMs, hard drives, or any other machine-readable storage medium, wherein, when the program code is loaded into and executed by a machine, such as a computer, the machine becomes an apparatus for practicing the disclosed subject matter. In the case of program code execution on programmable computers, the computing device generally includes a processor, a storage medium readable by the processor (including volatile and non-volatile memory and/or storage elements), at least one input device, and at least one output device. One or more programs that can implement or utilize the Wyner-Ziv Successive Refinement Video Compression methods of the disclosed subject matter, e.g. through the use of a data processing API, reusable controls, or the like, are preferably implemented in a high level procedural or object oriented programming language to communicate with a computer system. However, the program(s) can be implemented in assembly or machine language, if desired. In any case, the language can be a compiled or interpreted language, and combined with hardware implementations.

The methods and apparatus of the disclosed subject matter can also be practiced via communications embodied in the form of program code that is transmitted over some transmission medium, such as over electrical wiring or cabling, through fiber optics, or via any other form of transmission, wherein, when the program code is received and loaded into and executed by a machine, such as an EPROM, a gate array, a programmable logic device (PLD), a client computer, etc., the machine becomes an apparatus for practicing the disclosed subject matter. When implemented on a general-purpose processor, the program code combines with the processor to provide a unique apparatus that operates to invoke the functionality of the disclosed subject matter. Additionally, any storage techniques used in connection with the disclosed subject matter can invariably be a combination of hardware and software.

Furthermore, the disclosed subject matter can be implemented as a system, method, apparatus, or article of manufacture using standard programming and/or engineering techniques to produce software, firmware, hardware, or any combination thereof to control a computer or processor based device to implement aspects detailed herein. The term “article of manufacture” (or alternatively, “computer program product”) where used herein is intended to encompass a computer program accessible from any computer-readable device, carrier, or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick). Additionally, it is known that a carrier wave can be employed to carry computer-readable electronic data such as those used in transmitting and receiving electronic mail or in accessing a network such as the Internet or a local area network (LAN).

The aforementioned systems have been described with respect to interaction between several components. It can be appreciated that such systems and components can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it should be noted that one or more components can be combined into a single component providing aggregate functionality or divided into several separate sub-components, and any one or more middle layers, such as a management layer, can be provided to communicatively couple to such sub-components in order to provide integrated functionality. Any components described herein can also interact with one or more other components not specifically described herein but generally known by those of skill in the art.

As will be appreciated, various portions of the disclosed systems above and methods below can include or consist of artificial intelligence or knowledge or rule based components, sub-components, processes, means, methodologies, or mechanisms (e.g., support vector machines, neural networks, expert systems, Bayesian belief networks, fuzzy logic, data fusion engines, classifiers . . . ). Such components, inter alia, can automate certain mechanisms or processes performed thereby to make portions of the systems and methods more adaptive as well as efficient and intelligent.

While the disclosed subject matter has been described in connection with the preferred embodiments of the various figures, it is to be understood that other similar embodiments can be used or modifications and additions can be made to the described embodiment for performing the same function of the disclosed subject matter without deviating therefrom. For example, while exemplary network environments of the disclosed subject matter are described in the context of a networked environment, such as a peer to peer networked environment, one skilled in the art will recognize that the disclosed subject matter is not limited thereto, and that the methods, as described in the present application can apply to any computing device or environment, such as a gaming console, handheld computer, portable computer, etc., whether wired or wireless, and can be applied to any number of such computing devices connected via a communications network, and interacting across the network. Furthermore, it should be emphasized that a variety of computer platforms, including handheld device operating systems and other application specific operating systems are contemplated, especially as the number of wireless networked devices continues to proliferate.

While exemplary embodiments refer to utilizing the disclosed subject matter in the context of particular programming language constructs, the disclosed subject matter is not so limited, but rather can be implemented in any language to provide methods for video coding and decoding. Still further, the disclosed subject matter can be implemented in or across a plurality of processing chips or devices, and storage can similarly be effected across a plurality of devices. Therefore, the disclosed subject matter should not be limited to any single embodiment, but rather should be construed in breadth and scope in accordance with the appended claims.

What is claimed is:

1. A method for coding and decoding a video sequence having a plurality of frames, comprising:
quantizing a first frame of the plurality of frames into a plurality of binaries;
partitioning the plurality of binaries into at least a base layer bin and an enhance layer bin;
compressing and transmitting the base layer bin and the enhance layer bin to a decoder;
decoding the base layer bin at the decoder using a first prediction frame to create a base layer reconstruction;
performing a motion estimation using the base layer reconstruction to determine a second prediction frame, the second prediction frame provides a more accurate motion estimation than the first prediction frame; and
decoding the enhance layer bin using the second prediction frame to create a refined frame reconstruction.

2. The method of claim 1, the quantizing includes quantizing according to an N-Queen pattern.

3. The method of claim 2, the quantizing includes quantizing using a quantization step having a value of one of 32 and 64.

4. The method of claim 1, the compressing includes coding according to a Slepian-Wolf Codec.

5. The method of claim 1, the decoding the base layer bin at the decoder using a first prediction frame includes using a prediction frame based at least in part on one of a motion compensated extrapolation result or a motion compensated interpolation result.

6. The method of claim 1, the performing a motion estimation using the base layer reconstruction includes using the base layer reconstruction as a block matching target.

7. The method of claim 1, the quantizing includes dithered quantizing.

8. The method of claim 1, further comprising:
using a low-pass filter to remove contours in the refined frame reconstruction.

9. The method of claim 1, further comprising:
performing a motion compensated refinement at the decoder after all bins are decoded to improve the quality of the refined frame reconstruction.

10. A computer readable medium comprising computer executable instructions for performing the method of claim 1.

11. A computing device comprising means for performing the method of claim 1.

12. A method for decoding a video stream having a plurality of video stream frames, comprising:
receiving at least one of the plurality of video stream frames;
processing the at least one of the plurality of video stream frames by a n-stage decoder component, where n is an integer, the processing further comprising:
dividing each received frame into n layers comprising higher and lower layers; and
successively reconstructing the n layers in the n-stage decoder component using lower layer reconstruction to refine motion vectors and side information in successively higher layer reconstruction.

13. The method of claim 12, the processing includes processing substantially in the pixel domain.

14. The method of claim 12, the processing includes processing substantially in the transform domain.

15. The method of claim 12, the processing further includes applying a low-pass filter after successively reconstructing the n layers.

16. The method of claim 12, the receiving includes receiving the at least one of the plurality of video stream frames over a network.

17. The method of claim 12, the receiving includes receiving the at least one of the plurality of video stream frames from a local data store.

18. A video compression system, comprising:
an application component that requests decoding of a plurality of frames of video data; and
a processing component for processing the plurality of frames in response to the request, the processing component further comprising:
a multi-stage decoder component that successively reconstructs each layer of a divided frame using a lower layer reconstruction to provide refined motion vectors and refined current frame information for higher layer reconstruction.

19. The system of claim 18, further comprising a multi-stage encoder component for dividing each frame of the plurality of frames into higher and lower layers;

20. The system of claim 18, further comprising at least one of a low-pass filter component that removes contours in a refined current frame and motion compensation refinement component that improves the quality of the refined current frame.
